(19) United States
(12) Patent Application Publication
(10) Pub. No.: US 2012/0225135 A1
(43) Pub. Date: Sep. 6, 2012

(54) Stabilised Chlorine Dioxide Solution

(75) Inventor: Tadeusz Krogulec, Ekatahuna (NZ)

(73) Assignee: SOUTHWELL IP LIMITED, Palmerston North (NZ)

(21) Appl. No.: 13/224,924

(22) Filed: Sep. 2, 2011

(30) Foreign Application Priority Data
Sep. 8, 2010 (NZ) NZ 587851

(51) Int. Cl. A01N 59/00; A01P 3/00; A01P 1/00

(52) U.S. Cl. 424/661

(57) ABSTRACT

An aqueous stabilised chlorine dioxide solution for use as a universal biocide. The stabilized solution preferably, but not necessarily, includes: (A) an effective stabilising amount of ClO₂⁻ ions; (B) an effective biocidal amount of ClO₂; (C) an acidulator sufficient to release ClO₂, in a safe manner, and (D) an amount of water qs. The solution may, but not necessarily, have a molar ratio of components (A):(B) that is from 20:1 to 1:20.

### CROSS REFERENCE TO RELATED APPLICATIONS

This application claims priority to New Zealand Patent Application NZ 587851, filed Sep. 8, 2010, which is hereby incorporated by reference herein as if fully set forth in its entirety.

### FIELD OF THE INVENTION

The invention relates to a stabilized solution of chlorine dioxide and the numerous uses of the solution in many areas of industry.

### BACKGROUND

Sanitizers are well known today and in frequent use. Chlorine dioxide, for example, is a well known disinfectant sanitizer and water treatment product. A major problem with the uses of carbon dioxide however is its delivery system. Until recently the only way of manufacturing chloride dioxide was by means of a generator. Two containers, one containing an acid the other a salt, were mixed together in a chamber and chlorine dioxide gas was generated and then metered into the water supply. For field applications this is not a satisfactory state of affairs.

The discovery of chlorine dioxide is generally credited to Sir Humphrey Davy, who reported the results of the reaction of potassium chlorate with sulfuric acid in the early 1800's. Chlorine dioxide today is generated for smaller applications by the reaction of sodium chlorite with chlorine, via either gaseous chlorination (Equation 1) or the reaction of sodium hypochlorite with hydrochloric acid (Equation 2).

Cl₂+2NaClO₂->2ClO₂+2NaCl (1)

HCl+NaOCl+2NaClO₂->2ClO₂+2NaCl+NaOH (2)

This chemistry was due to the pioneering efforts of J. F. Synan, J. D. MacMahon, and J. P. Vincent, of Mathieson Chemical Company, now Olin Corporation. In 1944, the generation of chlorine dioxide to control taste and odor problems at a potable water facility at Niagara Falls, N.Y., was reported.

This first successful application led to its use in other municipal potable water treatment facilities which had similar problems. Over the next 25 years researchers compared the disinfection efficiency of chlorine dioxide to that of the industry standard, chlorine.

In the mid to late 70's, researchers linked chlorination of potable water to increased cancer mortality rates. This increase in cancer mortality was tied to the production of trihalomethanes, THM's. The USEPA established 0.1 ppm as the maximum THM containment level for drinking water. Research in the area of THM reduction in potable water led to the EPA in 1983 suggesting the use of chlorine dioxide as an effective means of controlling THM's.

In 1986, there was an estimated 200-300 chlorine dioxide applications for potable water treatment in the USA, and applications in Europe numbered in the thousands.

Chlorine dioxide is being used increasingly to control microbiological growth in a number of different industries, including the dairy industry, the beverage industry, the pulp and paper industries, the fruit and vegetable processing industries, various canning plants, the poultry industry, the beef processing industry, and miscellaneous food processing applications. It is seeing increased use in municipal potable water treatment facilities and in industrial waste treatment facilities, because of its selectivity towards specific environmentally-objectionable waste materials, including phenols, sulfides, cyanides, thiosulfates, and mercaptans. It is being used in the oil and gas industry for down-hole applications as a well stimulation enhancement additive. Today, domestic industrial applications number in the thousands.

With the recent trend towards elimination of gaseous chlorine from the industrial plant site, there are increasing interests in exploring all the various alternatives to gaseous chlorine.

Acidified Sodium Chlorite, Stabilised Chlorine Dioxide and Chlorine Dioxide in Aqueous Diluent, Differences

Acidified Sodium Chlorite (ASC)

Is a weak colourless liquid with a, mild, chlorine like odour that is produced by adding a weak acid to solution of sodium chlorite (NaClO₂). The active ingredient (at pH 2.3 to 3.2) consists mainly of chlorous acid (HClO₂) in equilibrium with Chlorite ion (ClO₂⁻) and H⁺, ASC in solution consists mainly of chlorite ions (65 to 95% at pH 2.3 to 3.2, respectively, H⁺ ions and chlorous acid (35 to 45%) at pH 2.3 to 3.2, respectively. At pH>7 chlorine dioxide is the primary species present slowly decomposes to chlorate and chloride.

Chlorine dioxide is a relatively soluble compound with any that is generated in a fresh solution of ASC (generally)<3 ppm) tending to remain in solution. If the ASC solution is being sprayed, any chlorine dioxide in the solution is usually immediately off-gassed, with greater off gassing as spray particle size decreases (i.e. the surface area to volume ratio increases).

The use of ASC (depending on pH) may result in the production of the following four primary chlorine compounds and chloride (Cl⁻) when a food grade acid is mixed with sodium chlorite.

Chlorite (ClO₂⁻) chlorate (ClO₃), chlorous acid (HClO₂) and chlorine dioxide (ClO₂)

Acidified Sodium Chlorite Chemistry

ASC chemistry is the chemistry of chlorous acid (HClO²)

Oxidation States of Chlorine

| | | |
|---|---|---|
| ClO₄⁻ | +7 | Perchlorate ion |
| ClO₃⁻ | +5 | Chlorate Ions |
| ClO2 | +4 | Chlorine Dioxide |
| ClO₂⁻ | +3 | Chlorite ions |
| ClO or OCl⁻ | +1 | Hypochlorite ion |
| Cl2 | 0 | Chlorine (molecular) |
| Cl⁻ | −1 | Chlorite ion |

Stabilised Chlorine Dioxide

Stabilised chlorine dioxide is a misleading term that is unfortunately in widespread use. There are only trace amounts of chlorine dioxide in “stabilised chlorine dioxide”. The correct description of this is, “stabilised chlorite”. The chlorite is stabilised with a buffer and peroxide at a pH of about 7. Though chlorite, or stabilised chlorite is also an oxidising agent, it is not nearly as powerful as chlorine dioxide. Chlorine Dioxide, unlike chlorite, is a gas, the term “active” chlorine dioxide is used to distinguish between the real and unreal.

There is also a great deal of confusion relating to so-called “stabilized chlorine dioxide” solutions, which have little or none of the free ClO₂ molecule, but which predominate instead in chlorite ion. The claim is made that during use, the unstable chlorite can lead to a slow generation of ClO₂ but not with sufficient rapidity to provide any significant ClO₂ activity. The “stabilisation” of chlorine dioxide, by reaction of the ClO₂ with peroxides to form chlorite, has been taught in a number of patents, including those of Wentworth (U.S. Pat. No. 3,123,521) and McNicholas (U.S. Pat. No. 3,271,242). Other attempts to stably contain ClO₂ are found in U.S. Pat. No. 4,829,129, in which the molecule is claimed to be complexed with an organic polymer, and in U.S. Pat. No. 4,861,514, where ClO₂ is apparently maintained in a steady-state concentration, after its slow formation over many days, in a thickened aqueous solution comprising a gelling agent, a chlorite salt, and an aldehyde or acetal. In neither of these two patents does the resulting composition provide a simple stable solution, of freely-available ClO₂, appropriate for easy disinfecting or deodorising applications, without the presence of other solutes necessary for ClO₂ stabilisation. In addition, the application of the referenced compositions to a substrate intended for disinfection, would leave significant levels of dried residue upon evaporation of the aqueous solvent.

Active Chlorine Dioxide

The preferred method of manufacturing ClO², because it guarantees the best conversion to Chlorine Dioxide, and, limits, as much as possible the formation of by-products, is:

5NaClO²+4HCl→4ClO²+5NaCl+2H₂O.

Some very harmful substances—dioxins and furans, for example, and also trihalomethanes can be formed when chlorine products come in contact with organic matter, such as leaves and dirt. Dioxins and furans, both reasonably anticipated to be human carcinogens by the International Agency for Research on Cancer (IARC), are organochlorine compounds similar in structure to PCBs. They biodegrade very slowly and therefore build up in the bodies of animals and humans; dioxin and furan have even been detected in breast milk samples. Trihalomethanes, including the carcinogen chloroform are formed when chlorine reacts with carbon-containing organic matter. They can increase the risk of cancer and may damage the liver, kidneys, and nervous system, and increase rates of miscarriage and birth defects.

Sodium Hypochlorite and Chlorine Production

Sodium hypochlorite is another well known sanitizer and may be prepared by absorbing chlorine gas in cold sodium hydroxide solution:

2NaOH+Cl₂→NaCl+NaOCl+H₂O

Sodium hydroxide and chlorine are commercially produced by the chloralkali process, and there is no need to isolate them to prepare sodium hypochlorite. Hence NaOCl is prepared industrially by the electrolysis of sodium chloride solution with minimal separation between the anode and the cathode. The solution must be kept below 40° C. (by cooling coils) to prevent the formation of sodium chlorate.

The commercial solutions always contain significant amounts of sodium chloride (common salt) as the main byproduct, as seen in the equation above.

Household bleach sold for use in laundering clothes is a 3-6% solution of sodium hypochlorite at the time of manufacture. Strength varies from one formulation to another and gradually decreases with long storage.

A 12% solution is widely used in waterworks for the chlorination of water and a 15% solution is more commonly used for disinfection of waste water in treatment plants. High-test hypochlorite (HTH) is sold for chlorination of swimming pools and contains approximately 30% calcium hypochlorite. The crystalline salt is also sold for the same use; this salt usually contains less than 50% of calcium hypochlorite. However, the level of “active chlorine” may be much higher.

A weak solution of 1% household bleach in warm water is used to sanitize smooth surfaces prior to brewing of beer or wine. Surfaces must be rinsed to avoid imparting flavors to the brew; these chlorinated byproducts of sanitizing surfaces are also harmful.

US Government regulations (21 CFR Part 178) allow food processing equipment and food contact surfaces to be sanitized with solutions containing bleach provided the solution is allowed to drain adequately before contact with food, and the solutions do not exceed 200 parts per million (ppm) available chlorine (for example, one tablespoon of typical household bleach containing 5.25% sodium hypochlorite, per gallon of water). If higher concentrations are used, the surface must be rinsed with potable water after sanitizing.

A 1 in 5 dilution of household bleach with water (1 part bleach to 4 parts water) is effective against many bacteria and some viruses, and is often the disinfectant of choice in cleaning surfaces in hospitals (Primarily in the United States). The solution is corrosive, and needs to be thoroughly removed afterwards, so the bleach disinfection is sometimes followed by an ethanol disinfection. Chlorine products can be corrosive to plant and equipment, people and is also costly.

Sodium hypochlorite is a strong oxidizer. Products of the oxidation reactions are corrosive. Solutions burn skin and cause eye damage, particularly when used in concentrated forms. However, as recognized by the NFPA, only solutions containing more than 40% sodium hypochlorite by weight are considered hazardous oxidizers. Solutions less than 40% are classified as a moderate oxidizing hazard (NFPA 430, 2000). There are numerous report s and scientific papers discussing the problems associated with the use of chlorine. For example, the EPA in the 1990s raised skin absorption of chlorine to its top 10 carcinogen watch list, a professor of water chemistry at the University of Pittsburgh claimed that exposure to vaporized chemicals in the water supply through showering, bathing and inhalation was 2100 times greater than through drinking the water.

During the mid 1970's monitoring efforts began to identify widespread toxic contamination of the nation's drinking water supplies, epidemiological studies began to suggest a link between ingestion of toxic chemicals in the water and elevated cancer mortality risks. Since those studies were completed a variety of additional studies have strengthened the statistical connection between consumption of toxins in water and elevated cancer risks. Moreover, this basic concern has been heightened by other research discoveries.

“Chlorine is used almost universally in the treatment of public drinking water because of its toxic effect on harmful bacteria and other waterborne, disease-causing organisms. But there is a growing body of scientific evidence that shows that chlorine in drinking water may actually pose greater long-term dangers than those for which it was used to eliminate. These effects of chlorine may result from either ingestion or absorption through the skin. Scientific studies have linked chlorine and chlorination by-products to cancer of the bladder, liver, stomach, rectum and colon, as well as heart disease, arteriosclerosis (hardening of the arteries), anemia, high blood pressure, and allergic reactions. There is also evidence that shows that chlorine can destroy protein in our body and cause adverse effects on skin and hair.”

“The presence of chlorine in water may also contribute to the formation of chloramines in the water, which can cause taste and odor problems.”

The use of chlorine and sodium hypochlorite in their presently known form as sanitizers therefore poses serious problems to the public.

### OBJECT OF THE INVENTION

It is therefore an object of the invention to go some way in providing a useful and safe biocide or to at least provide the public with a useful choice.

### SUMMARY OF THE INVENTION

The invention provides a process for the generation of carbon dioxide in solution in which the resulting chloride dioxide solution is stable.

The chlorine dioxide solution is preferably stable for up to 14 months.

The invention also provides a stabilized chlorine dioxide solution. The solution is preferably stable for at least 14 months.

The invention also provides a method of using the stabilized chlorine dioxide solution. The solution is preferably stable for at least 14 months.

Surprisingly, the invention provides a unique process for producing a stabilized chlorine dioxide solution in which the presence of a certain amount of chlorite ion (ClO₂⁻—) in the aqueous medium helps stabilize the presence of ClO₂ in that solution.

The ClO₂ may be either:

added to the ClO₂ solution after it is formed;

be residually present from incomplete oxidation of a ClO₂— solution to ClO₂; or

result from the initial degradation of a pure ClO₂ solution, where some of the ClO₂ is reduced back to ClO₂⁻—.

The chlorine dioxide solution according to the invention has numerous uses. The product may be packed in a cardboard outer in which is contained a plastic “Jerry can” containing the salt and a smaller “pottle” containing further salts. The Gross weight is 2.3 kilograms and measures 0.135×0.135×0.200.

The contents make four hundred litres of usable product.

The product may be activated using the following procedure:

obtain a suitable container normally a two hundred litre drum;

preferably 500 grams of the salt is poured into water and agitated to dissolve it;

once dissolved, 500 mls of hydrochloric acid is added;

as the drum fills, 10 grams of salt may be taken from the pottle and to this may be added 500 mls of acid and 500 mls of water; and

the mixture is added to the drum and allowed to fill.

The uses may include any of the following:

Water Treatment

1:5000 to 1:15000 ration of active to water

Depending on the measured or perceived level of contamination of the water source.

Disinfectant

1:100 which insures log 5 reduction of major contaminants in under thirty seconds.

Field Use

A bowser of fifty thousand litre capacity is driven to a pond. The water is considered to be of medium level contamination. The bowser is filled to near capacity and five litres of the chlorine dioxide is added. The water is then safe for human consumption.

A field kitchen needs sanitation. A solution of one part of chlorine dioxide to one hundred parts of water is made up. The resultant diluent is used as a hard surface sanitiser:

There is perceived to be an odour problem. A diluent as in above is made and the area is sprayed.

Corpses may be treated with chlorine dioxide to delay the effects of bacterial invasion post-mortem. This matter has been discussed with Messrs. Mortech.

The uses for this product in all fields of sanitation are remarkable. It may be used as a mouth wash, as a fungicide as an antiseptic on cuts and it does not have the inherent health risks associated with chlorine.

From the perspective of ease of cartage and manufacture there is no need for disposal considerations as the packaging may simply be burnt.

A complete assessment of chlorine dioxide regarding toxicity etc. is available for determination on request.

Treatment of Ground Water

The general procedure for treating ground water is:

use antiseptic pumping equipment;

introduce ClO₂ at the storage tank using a metering device;

treat the water directly;

dosage depends on the bacterial loading. (It could range from 0.3 mgs/L to 1 mg per litre);

for normal circumstances preferably use 0.3 to 1 mg per litre. For bacterial content of 100 coliforms per 110 mls of water preferably use 0.5 mg/L;

after treatment, filter the water to rid it of impurities;

store in hermetically sealed container;

preferably, dosage is done on a weekly basis if the seal is not perfect; and

this water is fit for human consumption.

Health

The following are some of the areas where chlorine dioxide in solution according to the invention has proven effective:

acne; athlete's foot; anti-cross infection; amalgamated infections; comedones; condyloma; dandruff; dermal damage; eczema; psorisis; fungus Infections; herpes simplex; muscle damage; scabies; and tendon damage (Soak for ten to fifteen minutes with a solution of one to twenty or one to forty).

Oral Hygiene

The product according to the invention is effective against:

colibacillus; golden staphylococcus; white oidiomycetes; and for prevention of halitosis.

Halitosis is caused by microbes that can decompose thiamine acid, protein, peptone and non-vital epidermal cells into sulphides (H₂S, CH₃S. (CH₂)₂S. Gargling with 0.005% to 0.2% solution promptly decreases 50 to 50% of volatised sulphides.

Extrasomatic tests show it kills the main pathogenic bacteria that cause dental caries, e.g. 99% min S. mutans.

It is effective against anaerobic bacteria.

Further tests show that it is efficacious against actinomycetes of gingivitis, cocci, spirochetes caused by gingivitis, peridotites and gum bleeding.

Cleaning of Artificial Teeth

Gargle or soak in solution of 1 to 200

Eye Care

The product can be used in the sterilisation of contact lenses. Apply directly. The low dosage means it is harmless, non-toxic and does not irritate the eye;

Conjunctivitis, use 5 mg/L three times a day. Effective cure in three to five days; and the product is effective against styes, blood shot eyes etc.

Aquaculture

Primarily for sterilisation, antisepsis and the increase of oxygen in the water.

The dosage is safe and non-toxic to shrimps, prawns, fish and shellfish. The pharmacodynamic time is one dosage effective for 10 to 15 days.

The effect is to increase the water quality by oxidation when acting as a bactericide. It oxidises sulphides. Cyanide etc, inorganic compounds, chloro-phenols, thio and 2-tertiary amines and organic compounds that are harmful to shrimps and fish.

New bionomic oxygen is produced in the pond increasing the amount of dissolved oxygen. It effectively decreases the chemical oxygen consumption and values of ammonia and nitrogen in that environment.

Infectious bacteria, viruses and harmful algae are promptly killed in the pond. Prevents and cures all fish diseases.

Dosages in this area would preferably be in the region of 1500 to 1600 ml per cubic metre, evenly distributed.

Stockbreeding

Sterilisation, antisepsis and disease prevention.

Mushroom Growing

Sterilisation and antisepsis.

Animal Husbandry

The chlorine dioxide solution according to the invention kills the various bacterial breeding units, bacteria spores, viruses, pathogenic micro-organisms and their carriers i.e. spores, Helminth, algae etc.

The product is able to treat and prevent foot and mouth disease, porcine erysipelas, porcine pnuemopathy and other diseases caused by anthracoid spores, porcine viruses etc.

Removes odours and keeps a clean environment in sheds etc. The solution can be used as a spray or used to fumigate.

Fruit and Vegetable Post Harvest

Sterilisation and antisepsis is achieved by dipping and washing. Bacteria and fungi are destroyed. Any remaining pesticides are destroyed; the nett effect is to extend the shelf life of the product.

At Home

Removing odours in the refrigerator, place a solution in a bowl inside the fridge;

Toilet cleaning—directly into the bowl;

Dermatophytosis (Smelly Feet), wash feet and socks in solution.

Hospital and Medical

Instruments Sterilisation and antisepsis Rinse;

Wards Sterilisation and antisepsis Fumigate Removes odours; and

Sewage Sterilisation and antisepsis Treat Direct.

Miscellaneous Applications

Odour Abatement; Fumigation; Food and Beverage Industry;

Purifying water, cleaning plant and equipment, achieves sterilisation and antisepsis, apply as circumstances dictate;

Marine and Meat Products;

Shelf life extension and water quality, plant and equipment cleaning,

Odour abatement;

Water Circulation Systems Sterilisation, Iron and Manganese removal, algae control, apply directly to water

Petroleum Industry; and

Sterilisation, Iron and Manganese removal, algae control and bacteria control, apply directly to water.

Weaving, Paper Making, Printing and Dyeing Industries

Colour removal and Bleaching.

Sewage Treatment

Water Treatment in the Chemical, Textile, Papermaking and Dyeing Industries, apply direct to water.

General Food Industry

Sterilisation of work areas, conveyors, pipelines, transport, drinking water, tools, plant and equipment, working clothes, masks and head gear, spray or soak with 1 to 400 or 1 to 600 solution; and

Hotels Restaurants and Food Preparation Industries, all hard surfaces, spray or soak with 1 to 200 solution.

Around the Farm

| Item | Concentration | Method |
|---|---|---|
| Drinking Water | 1:5000-1:10000 | Add directly to water |
| Poultry Shed | 1:200-1:500 | Soak equipment for 5 mins |
| Milk Inhaler | 1:200-1:500 | Wash and rinse |
| Teat Disinfectant | 1:200-1:500 | Wash or spray direct |
| Milk anti-corrosive | 1:2000-1:5000 | Add as per rate |
| Disinfecting pipes | 1:500 | Wash and Flush |
| Animal hooves | 1:200-1:500 | Soak and Wipe |
| Working clothes | 1:500 | Soak pre wash |
| Various containers | 1:500-1:1000 | Clean and sanitise |

### BRIEF DESCRIPTION OF THE DRAWINGS

The invention will now be described in detail with reference to the following drawings in which

FIG. 1 shows an apparatus for the preparation of a chlorine dioxide solution;

FIG. 2 shows a graph of the ability of the chlorine dioxide solution to kill micro-organisms in fluids.

### DETAILED DESCRIPTION OF THE INVENTION

The applicant has found that aqueous ClO₂ solutions degrade in the following manner:

2ClO₂+H₂O+ClO₂⁻—+ClO₃+2H⁺

Although acidic solutions suppress the degradation, it is largely complete even in fairly acid environments.

The applicant has found that the presence of a certain amount of chlorite ion (ClO₂⁻ in the aqueous medium will help stabilise the presence of ClO₂ in that solution.

This ClO₂⁻— may be either
a) added to the ClO₂ solution after it is formed;
b) be residually present from incomplete oxidation of a ClO₂⁻— solution to ClO₂; or
c) result from the initial degradation of a pure ClO₂ solution, where some of the ClO₂ is reduced back to ClO₂⁻—.

The basis for the surprising stability of the ClO₂ in the presence of ClO₂ ion is putated to derive from the existence of a bimolecular charge-transfer complex involving one molecule each of ClO₂ and ClO₂⁻, as follows:

Q=1.6 mol⁻¹ClO₂+ClO₂⁻→[Cl₂O₄]⁻—

Thus, in solutions that contain both ClO₂ and ClO₂⁻, it can be expected that a portion of the ClO₂ will be tied up in complex form, and not be available per se as free ClO₂. However it should be also noted that the oxidation potential of [Cl₂O₄]⁻— is reportedly higher than that of ClO₂, so that ClO₂ solutions also containing ClO₂, and therefore the complex, ion would be expected to have a greater oxidation capacity than might be expected from simply that calculated from the level of ClO₂ present. This increased capacity would be expected to be associated with, for example, greater disinfection or a greater ability to destroy oral malodorants than a comparable ClO₂ solution with no additional chlorite present.

On the basis of the above data, and the theory underlying the need for a specific minimum amount of ClO₂⁻— ion to be present with respect to ClO₂ in order for ClO₂ to achieve a certain level of stability in the aqueous solution, the molar ratio of ClO2⁻—:ClO₂ preferably should be at least 1:1, but not more than about 20:1. Above that relative amount of chlorite ion with respect to chlorine dioxide, a significant generation of ClO₂ from the ClO₂⁻— will tend to create a desired increase of ClO₂ in the aqueous solution over a period of time, rather than maintaining a fairly constant level.

Stability Testing

The following test was used to analyse the sample.

Two methods of testing stability have been employed.

Apparatus for the Preparation of a Chlorine Dioxide Stock Solution I:

The entire apparatus must be set up in a fume cupboard.

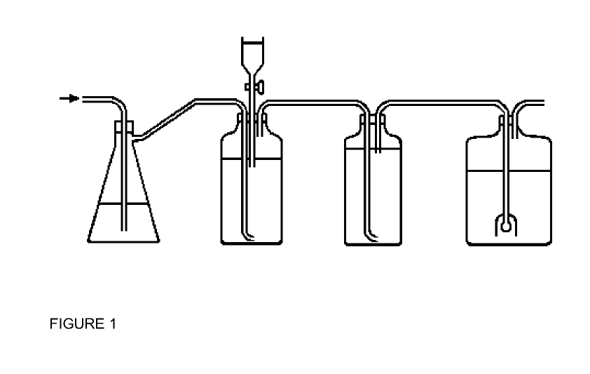

1. Connect the inlet of a 500-ml gas-washing bottle, filled with 100 ml of water GR, to a pure-air source or a compressed-nitrogen cylinder fitted with a pressure-reduction manometer.
2. Connect the outlet of this 500-ml gas-washing bottle with a PE tube to a gas-distribution tube fitted with a joint adapter into the left ground joint of a 500-ml three-necked flask that is standing on a magnetic stirrer, inserting the gas-distribution tube all the way to the bottom of the three-necked flask. Fill the three-necked flask with 100 ml of water GR. Place a 100-ml dropping funnel with a Teflon cock plug and a pressure-relief tube in position on the middle ground joint of the three-necked flask.
3. Connect the right ground joint of the flask to the inlet of a 500-ml gas-washing bottle. Fill 50 ml of the 1% sodium chlorite wash solution into this bottle.
4. Connect the outlet of this gas-washing bottle to the inlet of a 1000-ml gas-washing bottle, fitted with a sieving fit, containing 500 ml of water GR. The 1000-ml gas-washing bottle serves as an absorber unit for the chlorine dioxide and must be cooled externally with iced water. Refer to FIG. 1.

Preparation of a Chlorine Dioxide Stock Solution I:

To prepare the chlorine dioxide stock solution I fill 10 g of sodium chlorite for synthesis, 250 ml of water GR, and a magnetic-stirrer rod approximately 2 cm long into the 500-ml three-necked flask fill 25 ml of sulfuric acid 25% GR into the dropping funnel and close the funnel with a suitable ground-glass stopper. Stirring and the slow, dropwise addition of the sulfuric acid set off the development of the gaseous chlorine dioxide in the three-necked flask. Refer to FIG. 1.

The gaseous chlorine dioxide is expelled by blowing pure air or nitrogen as the carrier gas through the apparatus, in which process the gas-washing bottle containing water GR to the left of the three-necked flask serves as a bubble gauge. The gas-washing bottle to the right, filled with 50 ml of the 1% sodium chlorite wash solution, removes any traces of chlorine that may be present as a result of the formation of chlorine dioxide from sodium chlorite. The chlorine dioxide is collected or absorbed in the 1000-ml gas-washing bottle containing 500 ml of cooled water. The rate of flow of the carrier gas must be metered in such a way to ensure that the formed chlorine dioxide is promptly expelled. The stock solution I (from the 1000-ml gas-washing bottle), prepared according to the above schedule, can contain 250-600 mg/l of chlorine dioxide.

The sulfuric acid set off the development of the gaseous chlorine dioxide in the three-necked flask. Refer to FIG. 1.

Titrimetric Assay of the Chlorine Dioxide Stock Solution I:

In a 250-ml conical flask with a ground-glass stopper mix 2 g of potassium iodide GR, 50 ml of water GR, and 2 ml of sulfuric acid 25% GR. Into this solution pipette 25 ml of the chlorine dioxide stock solution I using a volumetric pipette. Leave the mixture to stand in the closed flask for 5 minutes in the absence of light. Titrate the released iodine with sodium thiosulfate solution 0.1 mol/l against zinc iodide-starch solution GR as the indicator. The colour changes from blue to colourless. Make a note of the amount of sodium thiosulfate solution 0.1 mol/l consumed in the titration step.

Notes Regarding Pipetting with the Volumetric Pipette:

To pipette the chlorine dioxide stock solution I, when expelling the pipette contents it is important always to insert the tip of the volumetric pipette in the solution previously filled into the conical flask as a measure to minimize any loss of the analyte.

Calculation:

mg chlorine dioxide per ml stock solution I=A×N×13.49 ml sample

A=Consumption of sodium thiosulfate solution 0.1 mol/l

N=Normality of the sodium thiosulfate solution 0.1 mol/l=0.1

The chlorine dioxide stock solution I prepared in this manner is used to prepare diluted working solutions (e.g. 100 mg/l). These dilutions must be used immediately, since they remain stable for a maximum time of one hour in the closed volumetric flask.

Example for the preparation of a working solution of 100 mg/l chlorine dioxide:

It has, for example, been titrimetrically calculated that the chlorine dioxide stock solution I has a concentration of 1.25 mg chlorine dioxide per ml. The following formula is employed for the preparation of a 100-mg/l chlorine dioxide working solution: 100/1.25=80

In other words, 80 ml of the 1.25 mg/ml chlorine dioxide stock solution is measured into a 100-ml volumetric flask with a buret and made up to the mark with water GR. The concentration is now 100 mg/l chlorine dioxide.

Results

It is a constant feature of the literature that if chlorine dioxide in aqueous solution away from UV light and under 30 degrees Celsius will have a long shelf-life. Secondly it was found various plastics were more accommodating of chlorine dioxide than others. The literature pointed to HDPE.

Therefore a batch was prepared using the system described in Chemistry and Manufacturing p. 17.

The batch was tested for the concentration of chlorine dioxide using US-Standard Methods AWWA, APHA, WCPF 17^{th} Edition (1989) described above the results are printed in Table 1 below. The results showed stability based on a 96 day trial.

Two further samples from the original batch were taken one was packed in an amber coloured PET bottle and the second in a HDPE plastic pouch.

Both were placed in an area out of direct sunlight and further the second sample was protected from light by a cardboard box.

Measurements of their voltage were taken using an ORP meter in accordance with the testing procedure described in the ORP related articles above.

The results are printed below in Tables 1, 2, and 3.

The trials were discontinued at 96 days, 9 months and 14 months.

If the solution were to kept and below 30 degrees Celsius and out of direct sunlight then a safe shelf-life would be about 12 months.

TABLE 1
Storage Stability Test - Chlorine Dioxide

| Test | | | | Statistical Analysis | | | | |
|---|---|---|---|---|---|---|---|---|
| Level | Air | | | | | | | Re- |
| 0.13 ppm | Vol | Found | Taken | | | Std | | covery |
| ClO₂ | (L) | ppm | ppm | n | Mean | Dev | CV | (%) |
| Day 1 | 116 | 0.133 | 0.130 | | | | | |
| | 112 | 0.128 | 0.130 | | | | | |
| | 116 | 0.128 | 0.130 | | | | | |
| | 117 | 0.126 | 0.130 | | | | | |
| | 119 | 0.115 | 0.130 | | | | | |
| | 104 | 0.127 | 0.130 | | | | | |
| | | | | 6 | 0.126 | 0.006 | 0.047 | 97.1 |
| Day 5 | 116 | 0.125 | 0.130 | | | | | |
| | 112 | 0.122 | 0.130 | | | | | |
| | 116 | 0.117 | 0.130 | | | | | |
| | 117 | 0.123 | 0.130 | | | | | |
| | 119 | 0.125 | 0.130 | | | | | |
| | 104 | 0.118 | 0.130 | | | | | |
| | | | | 6 | 0.122 | 0.003 | 0.028 | 93.6 |
| Day 15 | 116 | 0.133 | 0.130 | | | | | |
| | 112 | 0.129 | 0.130 | | | | | |
| | 116 | 0.127 | 0.130 | | | | | |
| | 117 | 0.125 | 0.130 | | | | | |
| | 119 | 0.131 | 0.130 | | | | | |
| | 104 | 0.157* | 0.130 | | | | | |
| | | | | 5 | 0.129 | 0.003 | 0.025 | 99.2 |
| Day 30 | 116 | 0.126 | 0.130 | | | | | |
| | 112 | 0.130 | 0.130 | | | | | |
| | 116 | 0.130 | 0.130 | | | | | |
| | 117 | 0.128 | 0.130 | | | | | |
| | 119 | 0.125 | 0.130 | | | | | |
| | 104 | 0.161* | 0.130 | | | | | |
| | | | | 5 | 0.128 | 0.002 | 0.018 | 98.3 |
| Day 48 | 116 | 0.131 | 0.130 | | | | | |
| | 112 | 0.131 | 0.130 | | | | | |
| | 116 | 0.127 | 0.130 | | | | | |
| | 117 | 0.128 | 0.130 | | | | | |
| | 119 | 0.127 | 0.130 | | | | | |
| | 104 | 0.164* | 0.130 | | | | | |
| | | | | 5 | 0.129 | 0.002 | 0.016 | 99.1 |
| Day 96 | 116 | 0.137 | 0.130 | | | | | |
| | 112 | 0.132 | 0.130 | | | | | |
| | 116 | 0.128 | 0.130 | | | | | |
| | 117 | 0.133 | 0.130 | | | | | |
| | 119 | LIA | 0.130 | | | | | |
| | 104 | 0.161* | 0.130 | | | | | |
| | | | | 4 | 0.133 | 0.004 | 0.028 | 102 |

LIA = Lost in Analysis
*Outlier—not used in statistical analysis

ORP Stability Tests

The second method used to prove stability is that of Oxygen reduction potential.

ORP technology has been gaining recognition worldwide and is found to be a reliable indicator of bacteriological water quality for sanitation—determine free—chlorine parameter. In swimming pool application, the ideal ORP value is approximately 700 mV where the Kill Time of E. coli bacteria is the fastest to ensure good water quality.

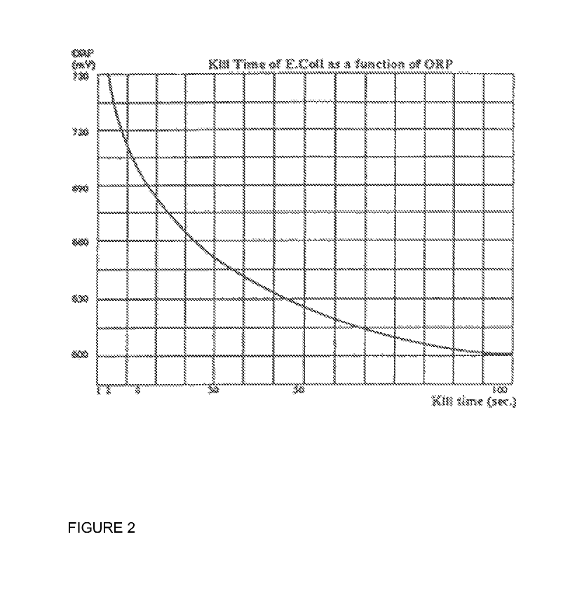

As can be seen from the results shown I FIG. 2, ORP indicates that most micro-organisms are killed in fluids in excess of 650 mV. Our results show that the ORP level of our product is constantly above 900 mV. Samples were kept in an office environment in Richmond on an exposed bench.

Sampling Equipment EUTECH INSTRUMENTS Waterproof ORPTestr 10

TABLE 2
Sample PET bottle

| Date/Year 2005 | mV |
|---|---|
| April 20 | 975 |
| May 10 | 980 |
| May 20 | 971 |
| June 12 | 970 |
| June 21 | 965 |
| July 10 | 960 |
| July 20 | 954 |
| Aug 8 | 926 |
| Aug 24 | 960 |
| Sept 5 | 955 |
| Sept 20 | 954 |
| Oct 12 | 948 |
| Oct 28 | 941 |

TABLE 3
Card Board Wine Cask

| Date/Year 2005/2006 | mV |
|---|---|
| July 7 | 970 |
| July 18 | 980 |
| August 3 | 987 |
| August 24 | 1143 |
| September 5 | 1135 |
| September 20 | 1130 |
| October 21 | 1036 |
| November 29 | 977 |
| January 18 | 1021 |
| March 14 | 1008 |
| April 20 | 991 |
| May 11 | 970 |
| June 2 | 970 |
| July 12 | 975 |

Fruit and Vegetable Industries

For many years fresh produce industries have been searching for an effective ready to use sanitiser that rapidly destroys all types of microorganisms and also provides maximum employee and environmental safety.

Likewise horticultural operations have been seeking broad-spectrum ecocides without harmful residuals or long lasting withholding periods.

### One Preferred Embodiment

### Preparation OF S1000 to Make 200 Litres

Ingredients are marked either “A” (sodium chlorite), “B” (hydrochloric acid) and “C” (sodium chlorite)—it being surprisingly found that the order of mixing of said components being essential to providing a unique solution of chlorine dioxide that has the surprising advantage of affording a sanitiser which remains stable over hitherto unimagined periods of time.

The unique method and resultant end product leads to reduced wastage of raw materials, a serious saving of time and resources, and an end product which satisfies a long-felt want in the marketplace.

take 500 grammes of “A” and add to 198 litres of water

wait for five minutes for “A” to dissolve

add 500 mls of agent “B”

add 1 litre of 30 to 32% hydrochloric acid to 1 litre of water.
(always add acid to water)

take 20 grammes of agent “C” and add to acid and water—a reaction will take place resulting in bubbling, heat and the giving off of a yellowish green gas.

when reaction is under way pour into holding vessel

screw down tops

The inventor has experimented with the process and has come up with the following variation:

Steps 1 and 2 remain the same

Step 3 changes. Rather than reacting the compound in the acid/water diluent one variation is to now add the necessary amount of compound C into the container (without reacting it) THEN—ADD THE ACID/WATER MIX

This makes for a better reaction and a safer one as one is not exposed to the gas as it is made. The draw back is that the reaction is slower and the finished goods must be left overnight for the reaction to take place completely.

Nevertheless, the process is safer and also allows for a stronger concentration of the active. What it means of course is that this will necessitate a certain amount of pre-planning as make-up cannot be left to the last minute.

Where can Chlorine Dioxide be Used

Post harvest sanitation of fruit and vegetables surface through flume wash to improve shelf life and freshness.

Removal of unwanted human pathogens on the surface of fruit and vegetables including E. coli and Listeria.

No rinse sanitation of equipment used to harvest produce.

Disinfection of flume and process waters including dump tanks and spray lines.

Sanitation of hard surfaces.

Reduction of pathogen load of amongst others:

| | | | |
|---|---|---|---|
| Alternaria | Aspergillus | | |
| Botrytis | | | |
| Cladosporium | Colletotrichum | Cylindocarpon | |
| Downey Mildew | | | |
| Erwina | European Canker | | |
| Fusarium | | | |
| Pencillium | Phoma | Phytophora | Powdery Mildew |

Drench Washing

Washing of the produce is undertaken in baths. This wash water is responsible for removing mainly soils off the produce. Hence microbial loading of the water increases, thereby offering a contamination vector of the other produce. It is therefore essential to treat this wash water with a disinfectant in order to improve and control the microbial quality of the water. In this way, one is able to offer some surface microbial reduction on the produce, thereby extending the shelf life.

When looking at reductions in counts there 3 are factors that determine the efficacy of the disinfecting solution: contact time, concentration and turbulence (turbulence within wash solutions). The shorter the contact time and the absence of turbulence require a higher concentration of Chlorine Dioxide.

Therefore, if washing of produce is under taken in a proper bath where there is water turbulence that drives the produce through the packing line. The recommended dosage is 250-500 ml to 1 Litre of Chlorine Dioxide per 1000 Litres water, with a contact time of 1 minute.

Washing of Deciduous Fruit

Deciduous fruit is washed in dump tanks or spray units with a disinfectant in order to inactivate the spores of the post harvest fungal diseases and to reduce bacterial contamination in wash waters from a food safety perspective. In many instances the water used is of poor quality in that it contains suspended solids, organics and is microbiologically contaminated. These factors complicate the requirements of meeting the customer's need of high quality fresh produce with no spoilage.

Dosage

250 ml to 500 ml Chlorine Dioxide per 1000 Litres of water

Washing of Citrus Fruit

Citrus is washed in dump tanks or high pressure spray units with a disinfectant in order to inactivate the spores of the post harvest fungal diseases and to reduce bacterial contamination in wash waters from a food safety perspective. In many instances the water used is of poor quality in that it contains suspended solids, organics and is microbiologically contaminated. These factors complicate the requirements of meeting the customer's need of high quality fresh produce with no spoilage.

Citrus Dosage

1 Litre Chlorine Dioxide per 1000 litres of water

Potatoes

Dose Potato dipping tank

2-4 Litres per 1000 lt of water

Product should topped up when dipping tank has lost 10% of tank volume

Dipping tank mix should be replaced every 50,000 kg of seed.

Plant and Machinery should be disinfected every before use

Sprayed with Knapsack—400 ml per 20 L of water

Hydroponics

Hydroponics or intensive farming needs strict bio-security control to eliminate the various vectors that can be used to spread disease in a hydroponics facility. We need to focus on each aspect to reduce the potential for the spread of disease by.

Treatment of fertigated water (fertiliser, nutrient and biological control agent (BCA) mixes) to prevent the spread of root diseases such as pythium, fusarium, phytophora, alternaria and rhizoctonia microorganisms. This is particularly necessary where nutrient gravel film systems are used where the fertigated water is continually re-cycled or where regulations require the fertigated water to be re-cycled. Dosage: 40 ml to 100 ml of Chlorine Dioxide per 1000 Litres of water. (2 L to 5 L per 50 000 Litres of water).

Dry Packing (I.e. Lettuces that are Packed Whole)

When produce is packed without washing, spraying with Chlorine Dioxide onto the produce, especially onto the cut ends and damaged areas, extends the shelf life. This will impact on the shelf life by reducing oxidative browning and microbial rot of produce. Chlorine Dioxide can be applied as a very fine spray onto the produce (do not wet the produce); this is done at a dosage of 2.5 L Chlorine Dioxide per 1000 Litres of water.

Hydro Cooling of Produce

Chlorine Dioxide has been successfully used in the hydro cooling of vegetables as it can inactivate microorganisms at refrigeration temperatures. The typical dosage is 1 L of Chlorine Dioxide to 1000 litres of water. We have found that not only do we keep the produce free of fungal contamination but the copper coils are also kept clean during the cooling cycles as well.

The list of vegetables, which have been treated, include, amongst others:

Beans; Carrots; Celery; Ginger; Lettuce; Melons; Onions; Okra; Peas; Parsnips; potatoes; Sweet potatoes; and Tomatoes.

Fruit and Vegetables

Vegetables

Vegetables of all kind are washed, cut and packed (e.g. in plastic bags). Customers are supermarkets and fast food producers.

Previous Treatment

Usually Chlorine is used for microbiological control with concentrations varying between 100-200 ppm.

Problems with Previous Treatment

Chlorine created a smell problem during processing in the processing hall with operators complaining of eye and skin irritation.

pH very often above 7.5 where microbiological treatment is often not effective with chlorine.

Batch Washing, Case Studies

Water change every 6-8 hrs. typical dosage: 6 ppm

Spraying, Typical Concentrations

Onion rings 6 ppm

Carrots 1 ppm

Benefits of Chlorine Dioxide

Shelf life increased by factor 3

Smell problem decreased significantly.

Washing of Cut Lettuce—Quality Requirements:

Salmonella zero

Listeria zero

E. coli zero.

Must pass sensory evaluation test criteria (no chlorine taste).

Appearance of lettuce must be good.

TPC must be within guidelines at day 10.

TPC=Total Plate Count (microbiological surface contamination)

Description of Old Chlorine Disinfection System.

Chlorine at 100-200 ppm. Dosed using sodium hypochlorite 12.5%

Terrible chlorine smell in factory with workers complaining of eye and skin irritations.

Impossible to control chlorine residual and required manual chemical addition every 15 minutes

pH control not possible as always creeping high.

Required to dump a lot of water to maintain chlorine residual which was high cost for chilling and extra ice

E. coli was not always zero.

Always concerned about Listeria as Listeria not affected by chlorine at low temperatures

TPC at day zero was inconsistent usually 1×10⁵, 3×10⁵ and occasional 1×10⁶ counts

Description of ClO₂ System

Chlorine dioxide at 1.0 ppm in 2 stage wash. First wash stage is 8 deg. C. and second wash stage is 2 deg. C.

Dosing is done automatically and automatic residual control.

No chemical smell in the factory at all.

Operators do a check on the dosing equipment every hour or so but do not add any chemicals manually.

pH is automatically controlled to 7.5.

Very little dumping of water and only chilled water is used. Chemical running cost is very low.

E. coli is always zero.

No concerns about Listeria as ClO₂ will easily kill Listeria at low temperatures.

TPC at day zero is consistent and always less than 7×10⁴

Producer of Frozen Corn Cobs, Kernels and Peas.

General process water contains 0.5 ppm chlorine (town supply).

Process Description

General process water contains 0.5 ppm chlorine (town supply).

Wash water is process water with 2 ppm chlorine dioxide added by metering device.

Corn is blanched and then cooled down. As the corn is cooling, microbiological growth can occur.

The corn is cooled by water spraying with 2 ppm chlorine dioxide (critical stage).

Advantages/Benefits:

No taste and odour influence on the corn.

ClO₂ works well in an environment of high organic loading.

No chlorine smell in the factory hall.

Easy generation, dosing and control of disinfection.

Processing of Spinach

Processing steps:

Spinach is moved dry (removing of beetles and caterpillars)

Washed with cold tap water

Blanching at 80°-90° C., cooling

The water from the last blanching segment in taken to a cooler

Production

Two processing lines, each 12 T/hr

Make-up water per line 12 m³/hr

Dosing of ClO₂

In the cooler ClO₂ is dosed, time proportional, intercooled with the last zone of the washing machine, dose: 100 g/hr

Processing of Tomatoes

Tomatoes are brought to the processing factory by truck and then transported by flume to the tomato paste production area. Chlorine Dioxide is used to destroy moulds on the tomatoes and in the flume tank.

Processing Steps:

Tomatoes are dumped from the truck onto a conveyor.

Coarse rinse with town water sprays to remove dirt and stems, leaves etc.

Tomatoes fall into flume tank (20 m³). The flume water is pumped to the sorting conveyor and back in a closed circuit with the tomatoes. Operators remove unacceptable product.

Make-up condensate water is continually added (5 m³/hr) from the tomato paste process.

Chlorine Dioxide is dosed into the flume water to maintain concentration of 0.2-0.4 ppm of ClO₂. pH of the flume water goes to 4.0 and this is not corrected as it is acceptable.

Method of Concentration Control:

Directly into flume. By-pass water is the condensate flow.

Control to 650 mV

This system is only used in wet weather and occasionally during dry weather. Mould is a bad problem when there is a lot of rain during harvest.

Previous Treatment

Used sodium hypochlorite and due to the high concentration of organic material in the flume water, had difficulty maintaining any free chlorine residual. This meant that moulds were not controlled and surfaces were fouled. In addition, operators would occasionally stop work due to chlorine smell in the sorting area.

Advantages/Benefits

Low concentration of chlorine dioxide is very effective in destruction of moulds on the tomatoes. These moulds would negatively affect the past production process if present.

Low concentration of chlorine dioxide is very effective in destruction of moulds in the flume water. If untreated, the moulds attach to surfaces of tanks and flumes and look like “meat”. Eventually, they foul screens and smell.

Chlorine dioxide effective at pH 4.0

No smell for operators

Very low running costs

No chlorinated organic by-products.

Possible build up of chlorite in the flume tank can affect the skin of operators when they handle the tomatoes i.e. hands, arms and face. If they wear gloves then this can be of help.

Processing of Potatoes

Potatoes are brought to the processing factory by truck and placed into heaps. They are then washed and cut into french fry shapes prior to freezing. Water used for processing is from a dam. It is flocculated and disinfected with chlorine dioxide.

Processing Steps:

Potatoes are cut and washed with chlorine dioxide treated water.

Chlorine Dioxide is flow pace dosed into the treated water at a dose of 1.0 ppm to maintain concentration of 0.5 ppm of ClO₂.

Method of Concentration Control:

Dosing directly into treated water

Previous Treatment

Previously used sodium hypochlorite and due to the high concentration of organic material in the dam water, had difficulty maintaining any free chlorine residual into factory. Processed product was developing an unusual taint. Chlorine dioxide treatment removed the taint.

Advantages/Benefits:

Chlorine dioxide dose at 1 ppm was a better micro-biological control agent than chlorine at 5-10 ppm.

No product taint.

Automatic operation simple and effective

Very low running costs

No chlorinated organic by-products.

Processing of Citrus

Washing stage: Immersed in water containing chlorine dioxide.

Aim is the reduction of:

Geotrichum Candidum Sour Rot Spores;

Penicillium Digitatum blue mould; and

Green mould.

Results:

2 ppm ClO₂ dosage

0.35 ppm ClO₂ residual

Dosage are controlled via redox as wash water is very dirty.

Wash water temperature 20 deg. C., pH 8

Outturns significantly less with ClO₂ than previous Nylate (bromine) or chlorine treatment

No taste or odour problems with the oranges.

Shelf life increased threefold.

Elimination of need for fungicide

Other Issues

Exhaust system was necessary for removal of excess ClO₂ and airborne spores.

A “Food Stock” Manufacturer

Processing Steps:

Onions are cut and fried on a hot plate resulting in complaints regarding cooking odours in industrial area.

Continuous fog of Chlorine Dioxide into extraction hood mixed at 5 Litres per 100 Litres of water and fogged at 3.5 Litres per Hour.

Method of Concentration Control

Dosing directly into treated water

Previous Treatment

None

Advantages/Benefits:

Odours eliminated

No product taint.

Automatic operation simple and effective

Very low running costs

No chlorinated organic by-products.

An Apple Orchardist

Packs fruit for local markets in a year round operation. Water in the flume gets very discoloured and malodorous from decayed fruit ex cool store and CA storage. Flume and water dump approximately 14,500 Litres capacity.

Processing Steps:

Shock dose 10 Litres Chlorine dioxide.

Add 3 Litres each week when “topping-up” water level.

Method of Concentration Control:

Dosing directly into treated water

Previous Treatment:

Chlorine.

Advantages/Benefits:

Water visibly clearer and not malodorous.

No product taint

No product taint.

No fermentation of pulpy fruit in the waste bins

Simple and effective.

Very low running costs

No chlorinated organic by-products.

Client intends to drench apples, pears, peaches prior to cool storage to prevent spoilage organisms infecting stem punctures etc.

A Medical equipment supplier Sales of new and used equipment plus Hire

A special inflatable mattress returned from hire with bad smoke odours

Processing Steps:

Wash with 1 litre Chlorine dioxide to 10 Litres of water.

Leave in shade for 30 minutes and allow to dry in air

Method of Concentration Control:

Dosing directly into water

Advantages/Benefits:

Mattress completely odour free

Mattress sanitised

No need to throw the mattress away.

No fermentation of pulpy fruit in the waste bins

Automatic operation simple and effective

Very low running costs

No chlorinated organic by-products.

Fumigation

SARD. (Specific Apple Replant Disorder)

Disease Controls

For the control of soil borne fungal and bacterial pathogens

Directions for Use
1. Work ground to a fine tilth before rain.
2. Apply Chlorine Dioxide at a rate of 60 Litres per ha, plus an Organo-Silicone such as Rhino at 100 mls/100 lt.
3. Apply a minimum of 500 Litres of water per ha.
4. Incorporate into soil by renovator immediately.
5. Plant trees/plants into ground.
6. Individual plant applications should be made at 1 L per 100 L plus Organo-Silicone such as Rhino @ 100 mls/100 lt

Apply a minimum of 20 Litres of mixed product per planting hole.

A soil conditioner and/or nutritional supplement should follow all applications.

Bacterial pathogens isolated from raw vegetables

| Vegetable | Country | Pathogen | Prevalence % | Reference |
|---|---|---|---|---|
| Alfalfa | U.S.A | Aeromonas | | Callister (1989) |
| Artichoke | Spain | Salmonella 3/25 | 12. | Ruiz et al. (1987b) |
| Asparagus | U.S.A | Aeromonas | | Berrang et al. |
| Bean sprouts | Malaysia | L. monocytogenes | 85 | |
| | Malaysia | Salmonella | 20 | Arumugaswamy |
| | Sweden | Salmonella | | Andersson Jong |
| | Thailand | Salmonella | 8.7 | Jerngklinchan (1993) |
| Beet leaves | Spain | Salmonella 4/52 | 7.7 | Ruiz et al. (1987b) |
| Broccoli | Canada | L. monocytogenes | 13.3 | Odumeru et al. (1997) |
| | U.S.A | Aeromonas | | Berrang et al. (1989) |
| | U.S.A | Aeromonas 5/16 | 31.3 | Callister Agger |
| Cabbage | Canada | L. monocytogenes | 2.2 | Schlech et al. (1983) |
| | Canada | L. monocytogenes 1/15 | 6.7 | Odumeru et al. (1997) |
| | Mexico | E. coli O157:H7 1/4 | 25.0 | Zepeda-Lopez (1995) |
| | Peru | V. chlolerae | | Swerdlow et al. |
| | Saudi Arabia | L. monocytogenes | | Salamah (1993) |
| | Saudi Arabia | Y. enterocolitica | | Salamah (1993) |
| | Spain | Salmonella 7/41 | 17 | Ruiz et al. (1987b) |
| | U.S.A | C. botulinum 1/337 | 0.3 | Lilly et al. (1996) |
| | U.S.A | L. monocytogenes 1/92 | 1.1 | Heisick et al. (1989b) |
| Carrot | Lebanon | Staphylococcus | 14.3 | Abdelnoor et al. |
| | Saudi Arabia | L. monocytogenes | | Salamah (1993) |
| | Saudi Arabia | Y. enterocolitica | | Salamah (1993) |
| Cauliflower | Netherlands | Salmonella 1/13 | 7.7 | Tamminga et al. |
| | Spain | Salmonella 1/23 | 4.5 | Ruiz et. al. (1987b) |
| | U.S.A | Aeromonas | | Berrang et al. (1989) |
| Celery | Mexico | E. coli O157:H7 6/34 | 17.6 | Zepeda-Lopez (1995) |
| | Spain | Salmonella 2/26 | 7.7 | Ruiz et al. (1987b) |
| Chili | Surinam | Salmonella 5/16 | 31.3 | Tamminga et al. |
| Cilantro | Mexico | E. coli O157:H7 8/41 | 19.5 | Lopez et al. (1995) |
| Coriander | Mexico | E. coli O157:H7 2/10 | 20.0 | Lopez et al. (1995) |
| Cress sprouts | U.S.A | B. cereus | | Portnoy et al. (1976) |
| Cucumber | Malaysia | L. monocytogenes 4/5 | 80 | Arumugaswamy |
| | Pakistan | L. monocytogenes 1/15 | 6.7 | Vahidy (1992) |
| | Saudi Arabia | L. monocytogenes | | Salamah (1993) |
| | Saudi Arabia | Y. enterocolitica | | Salamah (1993) |
| | U.S.A | L. monocytogenes | | Heisick et al. (1989b) |
| Egg plant | Netherlands | Salmonella 2/13 | 1.5 | Tamminga |
| Endive | Netherlands | Salmonella 2/26 | 7.7 | Tamminga |
| Fennel | Italy | Salmonella 4/89 | 71.9 | Ercolani |
| Green onion | Canada | Campylobacter 1/40 | 2.5 | Park, Sanders |
| Leafy veg. | Malaysia | Salmonella 1/24 | 4 | Arumugaswamy |
| | Malaysia | L. monocytogenes 22 | 22.7 | Arumugaswamy |
| Leeks | Spain | L. monocytogenes | 20 | de Simon et al. |
| Lettuce | Italy | Salmonella 82/120 | | |
| | Canada | Campylobacter 2/67 | 3.1 | Park, Sanders (1992) |
| | Canada | L. monocytogenes 3/15 | 20 | Odumeru et al. (1997) |
| | Lebanon | Staphylococcus | 14.3 | Abdelnoor et al. (1983) |
| | Netherlands | Salmonella 2/28 | 7.1 | Tamminga et al. (1978) |
| Lettuce | Saudi Arabia | L. monocytogenes | | Salamah (1993) |
| | Saudi Arabia | Y. enterocolitica | | Salamah (1993) |
| | Spain | Salmonella | | Ruiz et al.(1987b) |
| | U.S.A | Aeromonas | | Callister, Agger (1989) |
| Mungbean | U.S.A | Salmonella | | O. Mahony et al. (1990) |
| Mushrooms | U.S.A | C. jejuni 3/200 | 1.5 | Doyle, Schoeni (1986) |
| Mustard cress | U.K. | Salmonella | | Joce et al. (1990) |
| Mustard sprouts | U.S.A | B. cereus | | Portnoy et al. (1976) |
| | Canada | Campylobacter 1/42 | 2.4 | Park, Sanders (1992) |
| Parsley | Egypt | Shigella 1/250 | 0.4 | Satchell et al. (1990) |
| | Lebanon | Staphylococcus | 7.7 | Abdelnoor et al. (1983) |
| | Spain | Salmonella1/23 | 4.3 | Ruiz et al. (1987b) |
| Pepper | Canada | L. monocytogenes 1/15 | 6.7 | Odumeru et al. (1997) |
| | Sweden | Salmonella | | Andersson et al. (1989) |
| | U.S.A | C. botulinum 1/201 | 0.5 | Lilly et al. (1996) |
| | U.S.A | Aeromonas | | Callister, Agger (1989) |
| Potatoes | Saudi Arabia | L. monocytogenes | | Salamah (1993) |
| | Saudi Arabia | Y. enterocolitica | | Salamah (1993) |
| | Spain | L. monocytogenes 2/12 | 16.7 | de Simon et al. (1992) |
| | U.S.A | L. monocytogenes 19/70 | 27.1 | Heisick et al. (1989a) |
| | U.S.A | L. monocytogenes 28/132 | 21.1 | Heisick et al. (1989b) |
| | Canada | Campylobacter 1/63 | 1.6 | Park and Sanders (1992) |
| Prepack salads | N. Ireland | L. monocytogenes 3/21 | 14.3 | Harvey, Gilmour |
| | U.K. | L. monocytogenes 4/60 | 13.3 | Sizmur, Walker (1988) |
| | U.K. | L. monocytogenes | | Velani, Roberts (1991) |
| Radish | Lebanon | Staphylococcus | 6.3% | Abdelnoor et al. (1983) |
| | Saudi Arabia | L. monocytogenes | | Salamah (1993) |
| | Saudi Arabia | Y. enterocolitica | | Salamah (1993) |
| | U.S.A | L. monocytogenes 25/68 | 36.8 | Heisick et al. (1989a) |
| | Canada | Campylobacter 2/74 | 2.7 | Park and Sanders (1992) |
| | U.S.A | L. monocytogenes 19/132 | 14.4 | Heisick et al. (1989b) |
| Salad greens | Egypt | Salmonella 1/250 | 0.4 | Satchell et al. (1990) |
| | U.K. | S. aureus 13/256 | 5.1 | Houang et al. (1991) |
| Salad veg. | Canada | L. monocytogenes 6/15 | 40 | Odumeru et al. (1997) |
| | Egypt | Shigella 3/250 | 1.2 | Satchell et al. (1990) |
| | Egypt | S. aureus 3/36 | 8.3 | Satchell et al. (1990) |
| | Spain | Aeromonas 2/33 | 6.1 | Garcia-Gimeno (1996a) |
| | Spain | L. monocytogenes | 30 | Garcia-Gimeno. |
| | U.S.A | Staphylococcus | | Harris et al. (1975) |
| | Germany | L. monocytogenes 6/263 | 2.3 | Breer (1992) |
| | N. Ireland | L. monocytogenes 4/16 | 25 | Harvey, Gilmour (1993) |
| | U.S.A | C. botulinum 2/82 | 2.4 | Lilly et al. (1996) |
| | U.K. | Y. enterocolitica | | Brockelhurst (1987) |
| Seed sprouts | Canada | Staphylococcus 13/54 | 24 | Prokopowich (1991) |
| Soybean sprouts | U.S.A | B. cereus | | Portnoy et al. (1976) |
| Spinach | Canada | Campylobacter | | Park and Sanders (1992) |
| | Spain | Salmonella 2/60 | 3.3 | Garcia-Villanova (1987b) |
| | U.S.A | Aeromonas 2/38 | 5.2 | Callister, Agger (1989) |
| Sprouting seed | U.S.A | B. cereus 56/98 | 57 | Harmon et al. (1987) |
| Tomato | Pakistan | L. monocytogenes 2/15 | 13.3 | Vahidy (1992) |
| | Egypt | Salmonella 2/250 | 0.8 | Satchell et al. (1990) |
| | France | Y. enterocolitica 4/58 | 7 | Catteau et al. (1985) |
| | France | Y. enterocolitica 15/30 | 50 | Darbas et al.(1985) |
| | Iraq | Salmonella 3/43 | 7 | Al-Hindawi (1979) |
| | Italy | L. monocytogenes 7/102 | 6.9 | Gola et al. (1990) |
| | Italy | Y. enterocolitica 1/102 | 1.0 | Gola et al. (1990) |
| | Spain | L. monocytogenes 8/103 | 7.8 | de Simon (1992) |
| | Spain | Salmonella 46/849 | 5.4 | Garcia-Villanova (1987a) |
| | Taiwan | L. monocytogenes 6/49 | 12.2 | Wong et al. (1990) |
| | U.K | L. monocytogenes 4/64 | 6.2 | MacGowan et al. (1994) |
| | U.S.A | Salmonella 4/50 | 8.0 | Rude et al. (1984) |

Examples of pathogens associated with fruits and vegetables involved in outbreaks of food-borne disease

| Agent Implicated | Suspected food | Reference |
|---|---|---|
| Bacillus cereus | Sprouts | Portnoy et al. (1976) |
| Campylobacter | Cucumber | Kirk et al. (1997) |
| Campylobacter jejuni | Lettuce | CDC (1998) |
| Clostridium botulinum | Vegetable salad | PHLS (1978) |
| Cryptosporidium | Apple cider | CDR (1991) |
| Cyclospora | Raspberries | Herwaldt et al. (1997) |
| E. Coli O157 | Radish sprouts | WHO (1996) |
| E. Coli O157 | Apple juice | CDC (1996) |
| E. Coli O157 | Apple cider | Beser et al. (1993) |
| E. Coli O157 | Iceberg lettuce | CDR (1997) |
| Fasciolia hepatica | Watercress | Hardman (1970) |
| Giardia | Vegetables, incl. | Mints et al. (1992) |
| | carrots | |
| Hepatitis A virus | Iceberg lettuce | Rosenblum et al. (1990) |
| Hepatitis A virus | Raspberries | Ramsay et al. (1989) |
| Hepatitis A virus | Strawberries | Niu et al. (1992) |
| Norwalk virus | Tossed salad | Lieb et al. (1985) |
| Salmonella | Agona coleslaw & | Clark et al. (1973) |
| | onions | |
| Salmonella | Miami watermelon | Gayler et al. (1955) |
| Salmonella | Oranienburg | CDC (1979) |
| | watermelon | |
| Salmonella | Poona cantaloupes | CDC (1991) |
| Salmonella | Saint-Paul beansprouts | O. Mahony et al. (1990) |
| Salmonella | Stanley alfalfa sprouts | Mahon et al. (1997) |
| Salmonella | Thompson root | Kano et al. (1996) |
| | vegetables | |
| Salmonella | Dried seaweed | Kano et al. (1996) |
| Shigella flexneri | Mixed salad | Dunn et al. (1995) |
| Shigella sonnei | Iceberg lettuce | Kapperud et al. (1995) |
| Shigella sonnei | Tossed salad | Martin et al. (1986) |
| Vibrio chlolerae | Salad crops & | Shuval, et al. (1989) |
| | vegetables | |

Pathogens of Most Concern

Salmonella

The antigenic scheme for classifying salmonellae recognizes more than 2300 serovars and, while all can be considered human pathogens, only about 200 are associated with human illness.

Shigella

Bacillary dysentery or shigellosis is caused by Shigella, of which there are four species: S. dysenteriae, S. flexneri, S. boydii and S. sonnei (Maurelli and Lampel, 1997). Most cases of shigellosis result from the ingestion of food or water contaminated with human feces. Like salmonellae and other pathogens present in feces, Shigella can contaminate raw fruits and vegetables by several routes, including insects and the hands of persons who handle the produce, although shigellosis is more often transmitted from person to person.

Escherichia coli

Escherichia coli is common in the normal microflora of the intestinal tracts of humans and other warm-blooded animals. Strains that cause diarrhoeal illness are categorized into groups on the basis of virulence properties, mechanisms of pathogenicity, clinical syndromes and antigenic characteristics. The major groups are designated as enterotoxigenic, enterohaemorrhagic, enteropathogenic, enteroinvasive, diffuse-adhering and enteroaggregative (Doyle et al., 1997).

Campylobacter

Campylobacter jejuni is a leading cause of bacterial enteritis in many countries. Reservoirs of this pathogen include several wild animals as well as poultry, cows, pigs and domestic pets (Nachamkin, 1997). While consumption of food of animal origin, particularly poultry, is largely responsible for infection, Campylobacter enteritis has also been associated with the consumption of raw fruits and vegetables (Bean and Griffin, 1990; Harris et al., 1996). Although Campylobacter does not grow at temperatures below 30° C. and is sensitive to acid pH, it can survive on cut fruits for sufficient time to be a risk to the consumer (Castillo and Escartin, 1994).

Yersinia enterocolitica

Yersinia enterocolitica can be found in a variety of terrestrial and freshwater ecosystems, including soil, vegetation and water in lakes, rivers, wells and streams (Kapperud, 1991), but most isolates from these sources lack virulence for humans. Pigs, however, frequently carry serotypes capable of causing human disease. The ability of Y. enterocolitica to grow at refrigeration temperature and its documented presence on raw produce raises concern about the potential of salad vegetables as causative vehicles of yersiniosis in humans. Seven percent of carrot samples obtained from eating establishments in France were reported to contain serotypes of Yersinia that may be pathogenic to humans (Catteau et al., 1985). In another study (Darbas et al., 1985), 50% of raw vegetables analysed contained nonpathogenic strains of Yersinia. Incidence was higher on root and leafy vegetables than on tomatoes or cucumbers. Certainly, application of improperly composted pig manure to vegetable fields should be avoided to reduce the possibility of pathogenic strains being present on produce when it reaches the consumer.

Listeria monocytogenes

Listeria monocytogenes is present in the intestinal tract of many animals, including humans, so it is not surprising that the organism can also be found in the faeces of these animals, on the land they occupy, in sewage, in soils to which raw sewage is applied and on plants which grow in these soils (Van Renterghem et al., 1991). The organism also exists in nature as a saprophyte, growing on decaying plant materials, so its presence on raw fruits and vegetables is not rare (Beuchat, 1992; 1996a; Beuchat et al, 1990). Surveys of fresh produce have revealed its presence on cabbage, cucumbers, potatoes and radishes in the U.S.A (Heisick et al., 1989), ready-to-eat salads in the U.K. (Sizmur and Walker, 1988), the Netherlands (Beckers et al., 1989), N. Ireland (Harvey and Gilmour, 1993) and Canada (Odumeru et al., 1997), tomatoes and cucumbers in Pakistan (Vahidy, 1992), and bean sprouts, sliced cucumbers and leafy vegetables in Malaysia (Arumugaswamy et al., 1994).

Staphylococcus aureus

Staphylococcus aureus is known to be carried in the nasal passages of healthy food handlers and has been detected on raw produce (Abdelnoor et al., 1983) and ready-to-eat vegetable salads (Houang et al., 1991). However, enterotoxigenic S. aureus does not compete well with other microorganisms normally present on raw fruits and vegetables, so spoilage caused by nonpathogenic microflora would probably precede the development of the high populations of this pathogen that would be needed for production of staphylococcal enterotoxin.

Clostridium species

Spores of Clostridium botulinum and Clostridium perfringens can be found both in soil and on raw fruits and vegetables. The high rate of respiration of salad vegetables can create an anaerobic environment in film-wrapped packages, thus favouring the growth of C. botulinum and botulinal toxin production. Botulism has been linked to coleslaw prepared from packaged, shredded cabbage (Solomon et al., 1990) and chopped garlic in oil (St. Louis et al., 1988). Studies have revealed that C. botulinum can produce toxin in polyvinyl film-packaged (Sugiyama and Yang, 1975) and vacuum-packaged mushrooms (Malizio and Johnson, 1991). It is important that the permeability characteristics of packaging films minimize the possibility of development of anaerobic conditions suitable for outgrowth of clostridial spores. Recognizing that anaerobic pockets may develop in tightly packed produce, even when films have high rates of oxygen and carbon dioxide permeability, an additional measure to prevent growth of C. botulinum is to store produce at less than 3° C.

Bacillus cereus

Spores of enterotoxigenic strains of Bacillus cereus are common in most types of soil. Some strains can grow at refrigeration temperatures. Foods other than raw fruits and vegetables are generally linked to illness implicating B. cereus. Illness associated with eating contaminated soy, mustard and cress sprouts has, however, been documented (Portnoy et al., 1976). Human illness tends to be restricted to self-limiting diarrhoea (enterotoxin) or vomiting (emetic toxin). However, emetic toxin-producing strains have produced liver failure and death by the food-borne route.

Vibrio species

Vibrio species are generally the predominant bacterial species in estuarine waters and are therefore associated with a great variety of fish and seafoods. There are 12 human pathogenic Vibrio species, of which Vibrio cholerae, V. parahaemolyticus and V. vulnificus are of greatest concern (Oliver and Kaper, 1997). Vibrio cholerae is the causative agent of cholera, one of the few food-borne diseases with epidemic and pandemic potential. Carriage of the organism by infected humans is important in transmission of disease. Water can become contaminated by raw sewage.

Viruses

Viruses can be excreted in large numbers by infected individuals (Cliver, 1997). Although viruses will not grow in or on foods, raw fruits and vegetables may serve as vehicles for infection.

Many food-associated outbreaks of hepatitis A have been recorded (Cliver, 1997). In most instances, these outbreaks have not appeared to depend on the stability of the virus in the food.

Shellfish taken from waters contaminated with human faeces have been the vehicle in most outbreaks, but any food handled by an infected person may become contaminated and transmit infection (Cliver, 1985). Hepatitis A infection has been linked to the consumption of lettuce (Rosenblum et al., 1990), diced tomatoes (Williams et al., 1994), raspberries (Ramsay and Upton, 1989; Reid and Robinson, 1987) and strawberries (Centers for Disease Control and Prevention, 1997a; Niu et al., 1992). Hernandez et al. (1997) suggested that lettuce contaminated with sewage could be a vehicle for hepatitis A virus and rotavirus. Lettuce obtained from farmer's markets were reported to contain hepatitis A virus. The extent to which hepatitis A and other viruses are removed from the surface of fruits and vegetables upon treatment with chemical disinfectants is not known.

The number of cases of food-borne disease caused by Norwalk-like viruses (i.e. Small Round Structured Viruses, or SRSV) appears to be on the increase (Bean and Griffin, 1990). Outbreaks have a pattern of transmission resembling that of hepatitis A. Ice made from contaminated water has been implicated as the vehicle in more than one outbreak but salad items have also been linked to Norwalk-like gastroenteritis (Karitsky et al., 1995). Workers who have prepared salads linked to viral gastroenteritis have been shown to have high antibody titers to NorWalk virus (Griffin et al., 1982; Gross et al., 1989; Iverson et al 1987). A non-typical outbreak of Norwalk virus gastroenteritis associated with exposure of celery to non-potable water has been reported (Warner, 1991). Studies have shown that viruses may persist for weeks or even months on vegetable crops and in soils that have been irrigated or fertilized with sewage wastes (Larkin et al., 1978). Rotaviruses, astroviruses, enteroviruses (polioviruses, echoviruses and coxsackie viruses), parvoviruses, adenoviruses and coronaviruses have been reported to be transmitted by foods on occasion (Cliver, 1994). At least one echovirus outbreak has been attributed to contaminated raw shredded cabbage (New York Department of Health, 1989).

Chlorine Dioxide in the Dairy Shed Environment

“The test chemical demonstrated effective bactericidal action, i.e. >log 5 reduction (or 99.999 kill, against all test organisms in 30 seconds of contact/exposure, except for bacillus cereus. The exposure time required to obtain an effective log reduction of Bacillus cereus is in excess of 30 minutes.” . . . Hills Laboratories test on the Southwell Product

The test organisms were:

Bacillus cereus

Campylobacter jejuni

Escherichia coli

Lactobacillus casei

Listeria monocytogenes

Salmonella menston

Applications:

General sanitiser

Biofilm removal

Spray for the treatment of mastitis.

Microbiological effectiveness of Chlorine dioxide at cold temperatures

| | CIO2 consumption | Contact time | Deactivation |
|---|---|---|---|
| Microorganisms | (ppm) | (min) | (%) |
| Saccharomyces | 1.3 ppm | 10 | 99.999 |
| diastaticus (70 percent | | | |
| sporulated) | | | |
| Pichia (Hansenula) | 3.8 ppm | 5 | 99.999 |
| anomala (20 percent | | | |
| sporulated) | | | |
| Lactobacillus | 2.5 ppm | 5 | 99.999 |
| frigidus | | | |
| Pediococcus | 2.5 ppm | 5 | 99.999 |
| damnosus | | | |
| Enterobacter | 2.1 ppm | 5 | 99.999 |
| Cloacae | | | |

Damnosus and Enterobacter cloacae were used as test germs. The bacteria were in the lag Phase where they show an increased disinfectant tolerance due to lacking fissiparous scars. The used sporulating yeast forms are also particularly resistant to disinfectants. The experiments showed that Chlorine Dioxide is outstandingly appropriate for the killing of beverage relevant bacteria when the residence time amounts to five minutes. Even at 4° C., a complete killing of persistent sporulating yeasts can be expected after ten minutes at the latest. Therefore, this method is perfectly appropriate for disinfection purposes in the beverage industry even at temperatures of about 4° C.

Experiments carried out by the same institute showed that other disinfectants with higher concentrations were by far not as effective as the Chlorine Dioxide Method.

A salicylic acid product with a 0.5 percent concentration did not achieve a quantitative killing rate with the used microorganisms after 30 minutes of residence time. Even after 30 minutes, the beverage specific vermin remained significantly traceable, only enterobacter cloacae was quantitatively detected in this period.

Chlorine Dioxide—Applications—Poultry

EXTENDER is used in food processing applications with a number of the following beneficial properties.
1. It does not have any pH limitations.
2. Its disinfectant (sterilisation) capabilities are not diminished at all in the presence of fats, oils, proteins, body fluids etc. because it has very selective and very few chemical reactions.
3. It is strongly soluble in water, therefore, it has a long-lasting residual which reduces the potential for cross infection or re-contamination.
4. It is a broad spectrum, fast acting disinfectant, effective against a wide range of bacteria, spores, fungi, and viruses at relatively low concentrations and short contact periods.
5. It is colourless, has a mild medicinal odour, low corrosivity to metals and the lowest acute toxicity rating from the EPA.
6. High efficacy against E. coli, salmonella, listeria, aspergillus, penicillium, staphylococcus etc.
7. High efficacy is obtained irrespective of pH.
8. Non-corrosive and non-staining of equipment.
9. Easy to apply and to monitor.
10. Meets HACCP (food safety) management requirements.
11. Cost effective.

Poultry Processing

Chlorine Dioxide has been used very successfully in poultry processing, as a processing aid that is added to process water maintaining good microbial quality thereby impacting on the quality maintenance and shelf-life of the produce.

Areas of Application

The following would be the points of application

1. Scalding tanks

2. Carcass sprayer

3. Spin chiller

4. Inside outside carcass washer

5. Dip tanks for fallen birds

Dosages
1. Treatment of the scalding tank water would be done at a dosage of 300 ml per 1000 litres of water and the residual would thereafter be controlled at 10-15 ppm.
2. Treatment of the carcass sprayer water would be at 500 ml per 1000 litres of water and controlled at a dosage of 25-50 ppm.
3. Treatment of the spin chillers would be done at a dosage of 300 ml per 1000 litres of water thereafter maintain a 10-15 ppm residual. A 25-50 ppm (at dosage of 500 ml-1 L per 1000 litres of water) dip solution could be made up for any birds that accidentally fall on the floor.

Fishing Tuna Long Liner in Tropical Marine Waters.

Tuna is caught, gutted and suspended in refrigerated seawater at 0.5 deg. C. and stored for between 3 to 9 days before landing and packaging.

Processing Steps:

Fish gutted

Immersed in RSW hold 2 Litres of Clo2 per 1000 Litres RSW

Advantages/Benefits:

Voyage time now sixteen days

High oxidation power guarantees sufficient disinfection

Appearance of gills and natural colour better than prior storage method

Fish is considered to be of a higher quality

Better customer acceptance.

Raw Shrimps/Prawns

Raw shrimp from farms (natural sea or rivers) are sent to a factory for processing.

Processing Steps:

Washing 5-10 ppm ClO₂

Sizing and peeling, washing with 2-3 ppm ClO₂

Final rinse 0.2-0.5 ppm ClO₂

Freezing

Method of Concentration Control:

Contact water meter, or by measurement

Advantages/Benefits:

High oxidation power guarantees sufficient disinfection

No influence by pH

No smell or taste after final rinse water

Better customer acceptance compared to chlorine treated shrimp

Improvement of TPC values

Malodorous Fishing Vessel

The vessel was experiencing bad odour problems. It was suspected that a crack had appeared in the hold wall that allowed organic material to pass into the foam insulation and generate bacteria causing the malodours and also resulted in the degradation of the fish because of unacceptable bacteria levels.

Processing Steps:

5-10 ppm added to chilled seawater through a venturi and sprayed on the catch.

Chilling

Method of Concentration Control

By measurement

Advantages/Benefits:

High oxidation power guarantees sufficient disinfection

No influence by pH

No smell or taste after treatment

Better customer acceptance compared to chlorine treated fish

Improvement of TPC values

No malodours

Ice Plant

A drum type ice making machine with the capacity of 2 MT per hour. The ice is used to pack fish in boxes.

Processing Steps:

400 mls per tonne added to town water supply through a dosage pump.

Advantages/Benefits:

High oxidation power guarantees sufficient disinfection

Dwell time of Clo2 release on contact with fish

No smell or taste after treatment

Ice drums cleaned of bio-film allowing better contact with drum giving better ice

Keeping qualities of fish enhanced

General Sanitation

Vegetable Crate Washing Plant

Processing Steps:

Washed in detergent

Passed through sanitation side and sprayed with ClO₂ 10 ppm

Advantages/Benefits

High oxidation power guarantees sufficient disinfection

Cleaner appearance of crates

No smell after treatment

Sanitation Fishing Holds

Processing Steps:

Gross filth removed and washed in detergent

Cleaned surface sprayed with 10 ppm ClO₂ solution

Advantages/Benefits

High oxidation power guarantees sufficient disinfection

E. coli is below level of detection

No concerns about Listeria as ClO₂ will easily kill Listeria at low temperatures.

TPC at day zero is consistent and always less than 7×10⁴

Southwell Water Treatment Overview

The Southwell system complies with the Drinking water standards of New Zealand and the product is listed as C61, Water treatment in Manual M15, New Zealand Food Safety Authority.

Potable water (Fit to drink) must comply with the Drinking water standards and as such have no coliforms present and comply with the listed criteria such as Iron and Manganese control.

Objectives

To remove bacteria, cysts and undesirable metals from the water supply.

Bacteria and Cysts

Take a review of the water supply and determine the level of contamination. The amount of chlorine dioxide required to decontaminate the water supply is proportionate to the degree of contamination.

Iron, Manganese etc.

Determine the quantity of the undesired substance and refer to the chart below.

System Dosing

Dosing the system depends entirely on the degree of sophistication of the application.

You could be faced a water supply sourced from ground water and once treated it will be consumed. In that case the determination of the degree of contamination, or even suspected degree of contamination, is to be measured or gauged and then the following formula should be applied;

| Heavily contaminated | 1 Litre | 5000 Litres of water |
|---|---|---|
| Mildly contaminated | 1 | 10000 |
| Low contamination | 1 | 15000 |

In a system where tanks and pumps are available we can be more specific

If the flow of water can be measured, timing how quickly it fills a container of a specific volume would judge the amount issuing from a tap and accurate measurements can be made.

Assessments of the degree of contamination of the existing system must be made as to the amount of amassed bio-film with the system. The system includes; processing and storage tanks and the interlinking pipes.

A shock dose introduced at 10 grammes of Product per tonne of storage will remove any algae or bio-film held in the system. In heavily contaminated systems debris will come through the tap. It is best to run the system until the water runs clear.

The next thing to determine is the presence of iron and/or manganese. In systems contaminated with these metals it is normal to have a tank that is used for their removal. The following table explains the system and the quantities for removal of various contaminants in the water supply. The product must be added to the outflow side of this tank before the water enters a filter (if any) and is independent of any product introduced as a sanitizer as all the chlorine dioxide may be used up in removing the metals. The product passes through the filter and is ready to be dosed for sanitation.

Sanitation dosing is very simple. Dose at 1.5 grammes of product per tonne of water.

| Flow of water per hour | Amount of Chlorine Dioxide required |
|---|---|
| (1000 Litres = 1 tonne) | Centilitre |
| 1000 | 1.5 |
| 5000 | 7.5 |
| 10000 | 15 |
| 50000 | 75 |
| 100000 | 150 |

To treat a flow rate of 165,000 Litres of water per hour add 100000+50000+10000+5000=165,000
150+75+15+7.5=197.5 centilitres per hour

Contaminants Removal

Aldehydes

Aldehydes oxidize to the corresponding carboxylic acid.

Formaldehyde initially to formic acid and finally to carbon dioxide

Paraformaldehyde can be depolymerised and eliminated completely by oxidation with chlorine dioxide.

Amines and Mercaptans

Between pH 5 and 9, 4.5 parts by weight of chlorine dioxide instantaneously oxidise's 1 part by weight of a mercaptan (expressed as sulphur) to the respective sulphonic acid/sulphonate compound, destroying the mercaptan odour.

Similarly, chlorine dioxide reacts with organic sulphides and disulphides, destroying the original odour.

The oxidation of amines depends on the pH of the reaction mixture and the degree of substitution of the amine.

Between pH 5 & 9, and average 10 parts by weight chlorine dioxide oxidises 1 part by weight of a tertiary aliphatic amine (expressed as nitrogen), destroying the amine odour.

At pH above 7, an average 5 parts by weight of chlorine dioxide oxidises 1 part by weight of a secondary aliphatic amine (expressed as nitrogen) removing all traces of amine odour.

The higher the pH of the reaction mixture (chlorine dioxide and tertiary and/or secondary aliphatic amines), the more rapidly oxidation proceeds.

Ammonia Plant

Chlorine dioxide is chosen because of its non-reactivity with the ammonia commonly present in this system.

The starting ClO₂ feed was 2 mg/l based on the total of system capacity and make up water over a 4-hour treatment period, once each day. Shortly after the initiation of ClO₂ feed, a residual of free and available chlorine (as ClO₂ via DPD method) was attained and reached a maximum of 0.9 mail before the ClO₂ feed was suspended for the day. After ClO₂ feeding was stopped for the day, there was a gradual drop in ClO₂ residual. It should be noted here that chlorine residuals, under the previous gas chlorine programme, were seldom observed.

Total microbio counts under the previous chlorine program averaged approximately 15,000 organisms/ml. During the ClO₂ program, these counts have dropped to 1-5 organisms/ml and often sterile plates are observed.

Cyanide Destruction

Chlorine dioxide oxidises simple cyanide to cyanate (a less toxic substance) and/or carbon dioxide and nitrogen. The end products depend on reaction conditions.

In neutral and alkaline solutions below pH 10, and average 2.5 parts by weight of chlorine dioxide oxidises 1 part by weight of cyanide ion to cyanate. [1]

Above pH 10 an average 5.5 parts by weight of chlorine dioxide oxidises 1 part by weight of cyanide ion to carbon dioxide and nitrogen. [3]

Between pH 8 and 10 a mixture of by-products is produced [2]

Chlorine dioxide does not react with cyanate ion, nor has it been observed to form cyanogen chloride during the oxidation of cyanide.

Chlorine dioxide also oxidises thiocyanate to sulphate and cyanate. In neutral solutions, an average 3.5 parts by weight of chlorine dioxide oxidises 1 part by weight of thiocyanate ion. [4]

[1] pH in the range 7.0 to 8.0

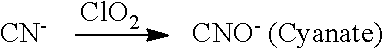

[2] pH in the range 8.0 to 10.0

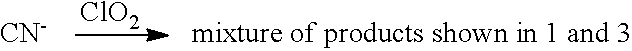

[3] pH greater than 10.0

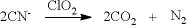

[4] pH 7

SCN⁻ClO₂OCN⁻+SO₄²⁻

Iron

Above pH 5 an average 1.2 parts by weight chlorine dioxide oxidises 1 part by weight soluble iron (ferrous) to insoluble iron (ferric).

ClO₂+5Fe(HCO₃)₂+3H₂O→5Fe(OH)₃+10CO₂+H⁺+Cl⁻

Above pH 5 the resulting ferric iron is 99% removable by a 0.45 micron filter after 5 minutes.

Manganese

The advantage chlorine dioxide has over chlorine is its speed of reaction. Chlorine reacts so slowly that manganese ions may still be in the water distribution system after 24 hours. Chlorine dioxide reacts much more rapidly with manganese oxidising it to manganese dioxide. After 5 minutes contact time, 99+% of the manganese may be removed through a 0.45 micron filter. 2.45 parts by weight of chlorine dioxide oxidises 1 part by weight of manganese. Best results are obtained when the pH is above 7.

2ClO₂+5Mn²⁺+6H₂O→5MnO₂+12H⁺+2Cl⁻

Nitrogen Compounds

Nitrogen oxides are hazardous and corrosive. Nitrous oxide (NO) and nitrogen dioxide (NO₂) are industrial effluents which result from fuel combustion, nitric acid manufacture and use, and from metal finishing operations which use nitrates, nitrites or nitric acid. Other sources include chemical processes in which nitrogen compounds are used as reagents.

Chlorine dioxide has been used to scrub these contaminants. Nitric oxide contained in gas discharges from coke kilns may be eliminated by chlorine dioxide oxidation.

The process is particularly convenient for continuous operation.

Phenol Destruction

Surface water often contains phenols from industrial effluents. Undesirable phenolic wastes are produced in the chemical, plastics, coke and petroleum refining industries. If chlorine is used for oxidation, highly toxic chlorophenols are formed. These chlorophenols can also cause taste and odour problems in drinking water. Ortho-chlorophenol is the most offensive of the phenol compounds. It is objectionable at concentrations as low as 1-2 ppb.

Treatment with chlorine dioxide can destroy chlorophenols. Below pH 10, 1.5 parts by weight of chlorine dioxide oxidises 1 part by weight of phenol to benzoquinone [1]. Above pH 10 an average of 3.3 parts by weight of chlorine dioxide oxidises 1 part by weight of phenol to a mixture thought to be low molecular weight, non-aromatic carboxylic acids (such as oxalic and maleic acids). At pH 7 the phenol reaction is rapid and complete; all phenols are consumed.

pH in the range 7.0 to 8.0

C₆H₅OH+ClO₂ (Benzoquinone)

pH in the range 8.0 to 10.0

C₆H₅OH+ClO₂ mixture of products shown in 1 and 3.

pH greater than 10.0

C₆H₅OH+ClO₂HOOCCH═CHCOOH+HOOC—COOH (Maleic acid+Oxalic acid)

Sulphides

Many industrial processes and waste water/effluents produce sulphide containing gases and waste products. These gases are frequently scrubbed with alkaline solutions and require treatment before discharge.

Between pH 5 and 9, an average 2.5-5 parts by weight of chlorine dioxide instantaneously oxidises 1 part by weight of hydrogen sulphide (expressed as sulphide ion) to the sulphate ion.

S⁻²+ClO₂SO₄²⁻

THM Precursors

The key to understanding why chlorine dioxide is so effective can be found in the differences in the reactions of chlorine dioxide and chlorine with trihalomethane (THM) precursors such as humic and fulvic acids.

Chlorine reacts with THM precursors by oxidation and electrophylic substitution to yield both volatile and non-volatile chlorinated organic substances (THMs).

Chlorine dioxide however reacts with THM precursors primarily by oxidation to make them non-reactive or unavailable for THM formation. This means that pre-treatment with chlorine dioxide has an inhibiting effect on THM formation when chlorine is subsequently used.

Bactericidal, Cysticidal, Oocysticidal and Virucidal Effects of Chlorine Dioxide in Contaminated Water

Chemical disinfection of drinking water is by far the most convenient approach to control transmission of infectious agents through water-borne route. However, problems include toxic byproducts resulting from the use of disinfecting agents, and the ability of certain microorganisms to resist the inactivation, particularly protozoan cysts and oocysts.

According to the US EPA Guide Standard and Protocols for Testing Microbiological Water Purifier, for a microbiological water purifier to successfully pass the evaluation test, it must remove, kill or inactivate all types disease-causing microorganisms from the water, including bacteria, viruses and protozoan oo(cysts) so as to render the processed water safe for drinking. Therefore, to qualify a microbiological water purifier it must inactivate all types of challenge microorganisms to meet the specified standards. Chlorine dioxide offers several advantages over chlorine for disinfection of drinking water. We have evaluated the ability of chlorine dioxide to inactivate prototypic water-borne bacteria, protozoa and viruses. Experiments were conducted using EPA waters contaminated with bacteria (Klebsiella terrigena, ATCC 33257; Salmonella choleraesuis, ATCC 10708; Escherichia coli, ATCC 11229; Legionella pneumophila, ATCC 33153), viruses (Poliovirus type 1, ATCC VR-59; Rotavirus SA-11, ATCC VR-899) and protozoa (Cryptosporidium parvum oocysts from the USDA, Beltsville, Md., and Giardia muris cysts from Oregon Health Sciences University) These experiments were conducted using the guidelines prescribed by the US EPA for testing microbiological water purifiers. Exposure to chlorine dioxide at a final concentration of 2 ppm in water for 10 minutes was effective in producing a >6−log 10 reduction in titer of all bacterial strains tested, at pH 5+0.2, 7+0.2 and 9+0.2 and at both 4+10 C and 20+50 C, respectively. Similar treatment of rotavirus and poliovirus produced >4−log 10 reduction in titer at neutral pH and pH 9.0.

The survival of bacteria and viruses were determined using standard assays.

Experiments are now underway to study the virucidal effect of chlorine dioxide at a lower pH. The protozoa part of the experiments included only spiked water at neutral pH which was exposed to either 3 or 4 ppm of chlorine dioxide for 30-minutes. For determination of cystidal and oocystidal effectiveness of chlorine dioxide, a bioassay for used. Treatment of water with both concentrations of chlorine dioxide (3 and 4 ppm) totally abolished infectivity of both the cysts and oocysts for mice indicating >3−log 10. Chlorine dioxide has been found highly effective in inactivating those bacteria, protozoa and viruses that are common contaminants of drinking water. In addition to the potential use of chlorine dioxide as water purifier as an alternative to chlorine, its applications in hospital settings, veterinary medicine and food industry will also be discussed.

The Use of Chlorine Dioxide in Disinfection of Wastewater

Disinfection is the most important step in the preparation of wastewater for reuse in irrigation, industry, ground water recharge and in the long term for drinking water purposes. The hazards of reused wastewaters are primarily health risks of infection. Bacteria and viruses may damage the health of those who come in contact with wastewater unless it has been adequately treated. In some countries it is allowed to dispose of biologically treated effluents which contain maximum geometrical average of 1000 total coliforms per 100 mL, or 200 fecal coli per 100 mL, during a period of 30 days. In California¹ a level of 23 total coliform organism per 100 mL is required for irrigation of golf courses, parks and pastures grazed by milking animals. For direct irrigation of food crops, a level of 2.2 total coliforms per 100 mL is required.

WHO² suggested health criteria for wastewater reused for irrigation of crops eaten raw not more than 100 coliform organisms per 100 mL in 80% of samples. According to Kott^{3,4} 20 to 40 mg/L of chlorine must be applied to biologically treated effluents for 6 hours to achieve a count of not more than 100 coliform per 100 mL. The Ministry of Health in Israel⁵ requires the disinfection of biologically treated effluents reused in irrigation, so that residual available chlorine should be found after one hour contact time, in accordance with the type of plants irrigated. Table 1 summarizes the criteria for treated wastewater reused in irrigation in Israel. Usually it is not easy to achieve these effluents criteria by chlorine disinfection. Chlorine has some significant disadvantages when used for wastewaters disinfection due to its reactions with the organic constituents, forming chloro-organics and with ammonia, forming chloramines, which are less effective than the free chlorine, and due to the large doses required to kill bacteria and inactivate viruses.

The purpose of this research is to investigate the feasibility of using ClO₂ as an alternative to Cl₂ in the disinfection of effluents and ensuring environmentally acceptable finished water suitable for various reuses, resulting from a more efficient treatment. The research intends to study the behavior of ClO₂ in wastewater effluents and in aqueous synthetic solutions containing organic and inorganic substances characteristic of effluents.

Experimental

ClO₂ was studied on Haifa municipal sewage treatment plant effluents, from activated sludge and high rate trickling filters and on organic free media, such as distilled and tap water. Chlorine dioxide was produced from sodium chlorite activated by HCl solution. Chlorine dioxide gas formed was driven off by bubbling air and carried through three empty traps in series before it was absorbed into distilled water, cooled with an ice bath. The ClO₂ mother solution was kept in refrigerator. Its concentration was determined at the beginning of each experiment.

The experiments were carried out using 3.5 L Duar glass flasks equipped with valve at the bottom, a cover and magnetic stirrer. To 3.0 liters of effluents various doses of ClO₂ mother solution were added, and the solution was kept in darkness while mixing. Samples were taken at various times for chemical and bacteriological analyses. The samples for bacteriological tests were taken in sterile bottles, which contained 100 mg sodium thiosulfate to stop the disinfection activity by reduction of ClO₂ and HOCl. In spite of washing step the ClO₂ mother solution never contained only ClO₂ but the following compounds as well: ClO₂⁻, ClO₃⁻, and free chlorine. Analytical methods for the determination of ClO₂ concentration in distilled water were studied, emphasizing the possibility of concentration determination of ClO₂ and other chlorine and oxygenated chlorine compounds after the contact with effluents. Knowing their concentration prior and after their addition to effluents is important for understanding the chemical reactions taking place in this system.

The methods studied included amperometric titration, potentiometric titration or colorimetric end point determination. All these studied analytical methods are not simple and are time consuming.

The method chosen⁶⁻⁹ is an amperometric dead stop end titration, using PAO phenylarsine oxide for determinations at pH 7.0 and above and Na₂S₂O₃ for determinations at pH 2 to 3.0 and pH 0.1. Both titrations are based on measuring the amount of I₂ liberated by oxidation of I⁻ in KI by the various chlorine and oxygenated chlorine compounds at various pH levels. The analytical techniques were in accordance with procedures outlined in the following references: for NO₂⁻—N⁸, COD⁸, NH₄⁺—N¹⁰ and NO₃⁻—N¹¹.

Results and Discussion

The behavior of chlorine dioxide has been investigated on sewage treatment plant effluents and compared to its behavior in organic free media, such as distilled and tap water. The aim of this research was to investigate whether secondary effects of chlorine dioxide application to effluents exist and if these affect its effectiveness as disinfectant. Particular attention has been paid to the interaction of ClO₂ with the inorganic and organic components of effluents and their effects on chlorine dioxide residuals.

The effects of varying chlorine dioxide doses, contact time and pH on residuals of ClO₂, ClO₂⁻, ClO₃⁻, HOCl and chloramines have been studied; as well as the effects on the destruction of total coliforms, fecal coli, streptococcus and coli phage, COD residual, organic nitrogen, ammonium, nitrite and nitrate ions.

Effect of Contact Time

Table II summarizes the contact time effects on the various chlorine and oxygenated chlorine constituents and on the final pH, by addition of ClO₂ dose 7.84 mg/L as ClO₂, or 20.6 mg/L as Cl₂. The concentration can be expressed as the specific constituent concentration or as Cl₂. The range of contact times investigated was from 10 minutes to 24 hours. The mother solution consisted as follows:

ClO₂ 294.6 mg/L as ClO₂ (774.2 mg/L as Cl₂)

ClO₂⁻ 201.4 mg/L as ClO₂⁻ (423.3 mg/L as Cl₂)

Free Chlorine HOCl 129.0 mg/L as Cl₂

Table II shows that the effluents have an immediate ClO₂ demand, its concentration decreased to 3.0 mg/L as ClO₂ already after 10 minutes, 1.0 mg/L after 3.5 hrs and it had disappeared after 24 hrs. A part of the ClO₂ was converted into ClO₂⁻, whose concentration increased with time. The effluents also have an immediate ClO₂⁻ demand. The ClO₂⁻ ion concentration introduced with ClO₂ solution decreased initially from 5.4 mg/L as ClO₂⁻ to 3.1 mg/L after 10 minutes, and subsequently increased with disappearance of ClO₂ up to a concentration of 7.0 mg/L after 24 hours. The residue ClO₂⁻ increases by increasing the ClO₂ solution doses, but is always lower than the initial concentration. It seems that the ClO₂⁻ ion is most stable of the various oxygenated chlorine compounds in the effluents system under investigation. In this experiment the ClO₃⁻ concentration was not determined. The free chlorine introduced with the ClO₂ mother solution is immediately consumed by the effluents, and it is not formed again. The free chlorine does not react with the ammonium ion in effluents, based on the absence of chloramines in the reacted effluents. This was further verified in an experiment where the ClO₂ mother solution was added into a synthetic aqueous ammonia solution. The ammonium ion concentration did not change and chloramines were not found, although the system contained some free chlorine; thus in the present system chlorine does not react with ammonia in the presence of ClO₂. It seems that in effluents system the free chlorine reacts or oxidizes organic and inorganic substances and disappears without forming chloramines. The total chlorine and oxygenated chlorine constituents expressed as Cl₂ decreased with time. This behavior was found typical to effluents, tap water and distilled water systems: the residual concentration of ClO₂ decreases with time and disappears after several hours and sometimes at periods longer than 24 hours for higher doses. The effluents pH after adding the ClO₂ solution did not change during the first 60 minutes, and only then increased with time to a value of 8.5 at 24 hrs.

Investigation of the effect of contact time of ClO₂ with effluents on COD has shown as in Table III an immediate decrease of COD from 238 to 215 mg/L, the latter was constant up to 24 hrs. This COD reduction is caused by oxidation of one of the ClO₂ solution constituents and not by the bacteria, which were immediately killed. This Table also shows that neither ClO₂ nor free chlorine has reacted with ammonia during 24 hrs. Presumably they reacted with other organic materials or oxidized other effluents' constituents, but did not react with the ammonia and did not form the chloramines. Moreover, the effluents' organic nitrogen did not decompose to ammonium ion, in the chlorine dioxide presence and the ClO₂ did not oxidized the ammonium ions to nitrites and nitrates, and did not form chloramines. This was evidenced by the constant ammonium ion concentration (34.75 mg/L NH₄⁺—N) and nitrates (0.08 mg/L NO₃⁻—N). This was further verified in a synthetic tap water system containing the following nitrogenous compounds: 15.2 mg/L NH₄⁺—N, 8.8 mg/L NO₂⁻—N and 2.2 mg/L NO₃⁻—N to which 19.2 mg/L ClO₂ was added, at neutral pH as shown in Table IV. The ClO₂ immediately reacted with the nitrites, and disappeared after 10 minutes forming chlorite ions.

The ClO₂ demand for oxidation of nitrites was very high: 5.5 mg/L ClO₂ were required for each 1 mg/L NO₂⁻—N oxidized to nitrates. The 19.2 mg/L ClO₂ dose was not sufficient to oxidize all the 8.8 mg/L NO₂⁻—N due to nitrites presence in the synthetic tap water based solution, and their concentration decreased to a constant value of 5.3 mg/L. 0.25 meq/L of the nitrites were oxidized to nitrates, which concentration increased by 0.25 meq/L, from 2.2 mg/L NO₃⁻—-N to a constant value of 6.0 mg/L NO₃⁻—N.

The experiment was carried out at a neutral pH where ClO₂ accepts only a single electron, as follows:

ClO₂+e-->ClO₂⁻

The amount of ClO₂ (0.25 meq/L) disappeared according to this reaction agrees with the above reported value of 0.25 meq/L NO₂⁻—N oxidized. Also, the ClO₂ specy did not react with the ammonia, and did not form chloramines in the synthetic systems and the ammonium ion concentration remained constant, 45.2 mg/L NH₄⁺—N, during the 24 hrs contact. The total nitrites and nitrates concentration remained constant 11 mg/L.

It is concluded that ClO₂ does not react with ammonia, but rapidly oxidizes nitrites to nitrates, in equivalent amount to its disappearance and chlorite ion formation. Moreover, the added chlorine and chlorite ion in the ClO₂ solution have not reacted with ammonium ion to form chloramines. These experiments demonstrate that effluents from biological nitrification or nitrification-denitrification plants, which does not efficiently oxidize ammonia to nitrates, may contain high nitrites concentrations demanding high ClO₂ doses to oxidize nitrites to nitrates. Theoretically 4.8 mg ClO₂ are required to oxidize 1 mg NO₂—N and only then additional ClO₂ may be available for disinfection. Practically 5.5 mg ClO₂ were required to oxidize each 1 mg NO₂⁻—N. This is a high disinfectant demand due to the presence of nitrites in nitrified effluents. An important conjecture is that since ClO₂ does not react with ammonia it is recommended as an efficient disinfectant for effluents from a conventional biological sewage treatment plant, without nitrification.

Effect of pH

ClO₂ is well recognized as a strong disinfectant active in a wide pH range. In fact, its activity depends upon pH, which controls the number of electrons it accepts, and the resulting compounds formed.

At pH 7 and above ClO₂ accepts one electron as follows

ClO₂+e-->ClO₂⁻

Since most of the reactions involved in water treatment take place within natural water and wastewaters pH range 7 to 8, a toxic chlorite ion is a major ClO₂ disinfection product. 60 to 70% of the ClO₂ is converted to ClO₂⁻ after 24 hours. In an acidic pH range, ClO₂ is converted to chloride ion by accepting 5 electrons as follows:

ClO₂+5e-->Cl⁻

Similarly, at low pH free chlorine converts to Cl⁻ and ClO₂⁻ is also converted to Cl⁻ by accepting 4 electrons as follows:

ClO₂⁻+4e-->Cl⁻

At highly acidic pH of less than 1.0 (pH 0.1) ClO₃⁻ converts into Cl⁻ by:

ClO₃⁻+6e-->Cl⁻

The pH effect was investigated in the pH range 3 to 10 by adding two doses of ClO₂ 19.2 mg/L and 37.5 mg/L to effluents at a constant 20 minutes contact time, as summarized in Table V. The ClO₂ mother solution contained

ClO₂=624.5 mg/L as ClO₂

ClO₂⁻=130 mg/L as ClO₂⁻

Cl₂=137 mg/L as Cl₂

The initial concentrations were calculated from the given dose of ClO₂ mother solution added to the effluent.

The Table shows that if original effluents, having a pH 7.5 are acidified, the ClO₂ concentration is almost constant. In the alkaline direction the ClO₂ concentration sharply decreases to 0.11 mg/L ClO₂ from 19.2 mg/L and to 5.23 mg/L from 37.5 mg/L. Thus ClO₂ is reduced to ClO₂⁻ or ClO₃⁻ in alkaline solution. These ions are not considered as disinfectants.

On the acidic side ClO₂ is stable up to pH 4.0 and therefore may serve as an efficient disinfectant within the pH range 7.5 to 4.0. At pH values lower than 3.5 its concentration is expected to decrease by reduction to Cl⁻ ion. Additionally Table V shows that free chlorine, at a dose of 19.2 mg/L has disappeared within all the pH range studied. Whereas, at the higher, 37.5 mg/L, dose, a residue was found only in the acidic pH. and it seems that the free chlorine rapidly reacts with organic compounds and disappears. It does not react with ammonia and does not form chloramines. These results lead to a conclusion which contrasts literature reports stating that ClO₂ is more active in the alkaline range. It is concluded from the present study that due to its stability ClO₂ should be used as disinfectant at the acidic pH range. An additional advantage characteristics to this acidic pH range is that less chlorite ion, considered as a toxic material, inefficient as disinfectant, is formed.

Effect of Disinfection on Microorganisms

Contact Time Effect

The effect of ClO₂ on microorganisms was studied using biologically treated effluents from Haifa municipal sewage treatment plant. The effects of ClO₂ dose level, contact time and pH on killing total coliforms, fecal coli, streptococcus, total count and E. coli phage were studied. In addition the ClO₂, oxygenated chlorine substances, free and combined chlorine residues were determined. The composition of ClO₂ mother solution in these experiments included:

ClO₂=441.9 mg/L as ClO₂

ClO₂⁻=23.0 mg/L as ClO₂⁻

HOCl=39.0 mg/L as Cl₂

Residual concentrations of ClO₂, ClO₂, HOCl and chloramines in disinfection experiments using various doses of ClO₂ and contact times between 5 to 35 min. are summarized in Table VI and Table VII shows the survival of microorganisms in this experiment.

Effluents disinfection with ClO₂ has shown 98.9% kill of fecal coli after 30 min. contact time, using a dose of 2.7 mg/L ClO₂. This small dose is insufficient to efficiently kill after 5 min. contact time. The killing efficiency was improved and contact times became shorter by increasing the ClO₂ dose levels. A dose of 10.8 mg/L ClO₂ was sufficient to reduce the fecal coli from 3.3×10 in effluents to 14 within 20 minutes and two organisms survived after 30 min. contact time. Such ClO₂ dose bacteriologically qualifies the effluents for unrestricted irrigation, conforming to the specification criteria in Israel, WHO and also the strict California requirements. It is important to point out that for unrestricted irrigation chemical parameters of effluents quality should also be accounted.

Effect of pH on Disinfection

Effect of final pH on disinfection of effluents after 30 min. contact time, on total count, coliforms, fecal coli and E. coli phage (all MPNS expressed per 100 mL) is shown in Table VIII. The control initial concentrations are also given.

Disinfection efficiency of ClO₂ was tested at pH range between 4 and 10.0. The original pH of the effluents was 7.5. Initially samples were taken to determine only the pH effect on the microorganisms level in comparison with their original concentration and reported in this table as “control”. Changes within the pH range studied were noted and subsequently accounted for. This Table shows that the pH is playing an important role on killing of these microorganisms. A dose of 9.86 mg/L ClO₂ is efficient for killing in the acidic and neutral pH range up to pH 8.2, while in the alkaline range an increase of microorganisms survival can be noticed.

In conclusion this experiment has proven the high efficiency of ClO₂ in effluent disinfection achieving high bacteriological quality of the treated water. An efficient disinfection of the effluents is achieved with relatively low ClO₂ doses and short contact times at the neutral and acidic pH range.

Conclusion

In conclusion our preliminary secret trials indicate a surprising and unique aspect illustrating the potential of stabilized ClO₂ as an efficient disinfectant in effluents, as compared to standard ClO₂ systems. Our trials have shown that although a comprehensive understanding of the mechanics of disinfection processes utilizing stabilised ClO₂ in effluent systems is still lacking the surprising and real advantages gained by using the stabilized ClO₂ methodologies of the present invention is of significant commercial value.

These studies are particularly important for a reliable disinfection of effluents intended for reuse.

TABLE I
Criteria for Wastewater Re-use in Irrigation in Israel

| | | residual available |
|---|---|---|
| | | chlorine, contact |
| type of irrigation | coliforms per 100 ml | time 1 hr |
| cooked vegetables | <250 | 0.15 mg/l |
| decidous fruits | (80% of samples) | |
| football fields & | | |
| golf courses | | |
| unrestricted crops | <12 (80%) | |
| parks & lawns | <3 (50%) | 0.5 mg/l |

TABLE II
Effect of Chlorine Dioxide Contact Time on ClO₂, ClO₂⁻, ClO₃⁻ and
HOCl Residuals in Effluents Treatment. ClO₂ Dose 7.84 mg/L.

| | | ClO₂ | | ClO₂⁻ | | HOCl | NH₂Cl | Sum Cl |
|---|---|---|---|---|---|---|---|---|
| Con- | | mg/L | | mg/L | | mg/L | mg/L | mg/L |
| tact | | as | as | as | as | as | as | as |
| Time | pH | ClO₂ | Cl₂ | ClO₂⁻ | Cl₂ | Cl₂ | Cl₂ | Cl₂ |
| 0 | 7.75 | 7.84* | 20.6* | 5.4* | 11.30* | 3.44* | 0 | 35.34* |
| min | | | | | | | | |
| 10 | 7.55 | 3.0 | 8.0 | 3.1 | 6.43 | 0.118 | 0 | 14.55 |
| min | | | | | | | | |
| 30 | 7.55 | 2.6 | 6.8 | 5.0 | 10.45 | 0 | 0 | 17.25 |
| min | | | | | | | | |
| 60 | 7.65 | 2.1 | 5.5 | 5.8 | 12.13 | 0 | 0 | 17.63 |
| min | | | | | | | | |
| 1.5 | 7.75 | 1.9 | 5.0 | 6.2 | 12.96 | 0 | 0 | 17.96 |
| hr | | | | | | | | |
| 2.5 | 7.90 | 1.5 | 3.8 | 6.23 | 13.10 | 0 | 0 | 16.90 |
| hr | | | | | | | | |
| 3.5 | 8.05 | 1.0 | 2.7 | 6.33 | 13.30 | 0 | 0 | 16.00 |
| hr | | | | | | | | |
| 24 | 8.50 | 0 | 0 | 7.0 | 14.66 | 0 | 0 | 14.66 |
| hr | | | | | | | | |

*Calculated

TABLE III
Effect of Chlorine Dioxide Contact Time on Effluent's Ammonium Nitrites,
Nitrates and COD. ClO₂ Dose 5.2 mg/L

| | | | | | | HOCl | Sum | | | | |
|---|---|---|---|---|---|---|---|---|---|---|---|
| | | | | ClO₂ | ClO₂⁻ | mg/L | Cl | | | | |
| | | | | mg/L | mg/L | mg/L | mg/L | COD | | | |
| | Contact | | | as | as | as | as | mg/L | NH₄—N | NO₂—N | NO₃—N |
| | Time | | pH | ClO₂ | ClO₂⁻ | Cl₂ | Cl₂ | O₂ | mg/L | mg/L | mg/L |
| Raw | 0 | | 7.4 | — | — | — | — | 238 | 38.1 | 0.0 | 0.08 |
| Effluent | 24 | hrs | 8.2 | — | — | — | — | 190 | 38.79 | 0.0 | 0.09 |
| Effluent | 0 | | | 5.2 | 2.6 | 2.2 | 21.2 | 235 | 34.6 | 0.0 | 0.07 |
| Calculated* | 10 | min | 7.3 | 1.9 | 2.8 | 0 | 10.5 | 216 | 34.75 | 0.0 | 0.08 |
| | 30 | min | 7.4 | 1.4 | 3.7 | 0 | 11.5 | 214 | 34.75 | 0.0 | 0.09 |
| | 1 | hr | 7.4 | 1.0 | 4.2 | 0 | 11.6 | 214 | | 0.0 | 0.15 |
| | 2 | hrs | 7.5 | 0.8 | 4.6 | 0 | 11.7 | 216 | | 0.0 | 0.09 |
| | 3½ | hrs | 7.6 | 0.4 | 5.0 | 0 | 11.5 | 216 | 35.54 | 0.0 | 0.09 |
| | 24 | hrs | 7.95 | 0 | 5.3 | 0 | 11.2 | 220 | 34.75 | 0.0 | 0.09 |

*Concentration calculated due to dilution by adding 36 ml ClO₂ stock solution to 3.50 L effluents. Chloramines concentration is zero.

TABLE IV
Effect of Chlorine Dioxide Contact Time on Ammonium Ion, Nitrites and
Nitrates Added to Tap Water, at Neutral pH. ClO₂ Dose 19.2 mg/L.

| | | | | HOCl + | | | | | |
|---|---|---|---|---|---|---|---|---|---|
| | | ClO₂ | ClO₂⁻ | NH₂Cl | Sum Cl | | | | |
| | | mg/L | mg/L | mg/L | mg/L | | | | Sum NO₂⁻ + |
| Contact | | as | as | as | as | NH₄⁺—N | NO₂⁻—N | NO₃⁻—N | NO₃⁻ |
| Time | pH | ClO₂ | ClO₂⁻ | Cl₂ | Cl₂ | mg/L | mg/L | mg/L | mg/L N |
| 0 | 7.3 | 19.2* | 11.8* | 7.3* | 82.7* | 45.2 | 8.8 | 2.2 | 11.0 |
| 10 min | 7.2 | 0 | — | 0.26 | | 45.2 | 5.3 | 5.9 | 11.2 |
| 30 min | 7.25 | 0 | 28.7 | 0.19 | 60.5 | 44.3 | 5.3 | 6.0 | 11.3 |
| 1 hr | 7.6 | 0.07 | 28.5 | 0.19 | 60.4 | 45.2 | 5.3 | 6.1 | 11.4 |
| 3 hrs | 7.9 | 0.03 | 29.5 | 0.19 | 62.2 | 45.2 | 5.3 | 16.0 | 11.4 |
| 24 hrs | 8.3 | 0.08 | 30.5 | 0.20 | 64.5 | 44.1 | 5.3 | — | |

*Calculated after addition of stock solution.

TABLE V
Effect of pH on Chlorine Dioxide, Chlorite Ion and Free Chlorine Residuals in
Effluents. ClO₂ Doses 19.2 mg/L and 37.5 mg/L. Contact Time 20 Minutes.

| DOSE 19.2 mg/L as ClO₂ | | | | | | DOSE 37.5 mg/L as ClO₂ | | | | |
|---|---|---|---|---|---|---|---|---|---|---|
| | | | | ClO₂₋ | Sum of | | | | | ClO₂₋ |
| | | ClO₂ | HOCl | mg/L | Cl | | | ClO₂ | HOCl | mg/L |
| pH | | mg/L as | mg/L | as | mg/L | pH | | mg/L as | mg/L | as |
| Ini.* | Final | ClO₂ | as Cl₂ | ClO₂₋ | as Cl₂ | Ini.* | Final | ClO₂ | as Cl₂ | ClO₂₋ |
| 7.5* | | 19.20* | 4.2* | 4.02* | 63.0* | 7.5* | | 37.50* | 8.23* | 7.8* |
| 4 | 3.4 | 4.66 | 0 | 3.03 | 18.63 | 4.0 | 3.5 | 25.84 | 0.55 | |
| 5 | 4.6 | 4.37 | 0 | 5.8.2 | 21.09 | 5.0 | 4.95 | 26.88 | 0.18 | |
| 6 | 6.45 | 4.95 | 0 | 5.68 | 24.95 | 6.0 | 6.05 | 24.20 | 0.21 | |
| 7.5 | 7.3 | 3.84 | 0 | 6.40 | 23.56 | 7.5 | 7.3 | 25.27 | 0.86 | |
| 9 | 8.8 | 1.27 | 0 | 10.63 | 25.70 | 9 | 8.8 | 15.13 | 0 | |
| 10 | 9.9 | 0.11 | 0 | 12.13 | 25.81 | 10 | 9.8 | 5.23 | 0 | |

Ini.*—Initial
*The initial concentrations calculated from the given dose of ClO₂ mother solution. Chloramines concentration is zero.

TABLE VI
Residual ClO₂, ClO₂₋ & HOCl in mg/L in Disinfection of Trickling Filters
Effluents with Various Doses of ClO₂. 2.7, 7.8 and 10.8 mg/L.

| | | | | | DOSE 7.8 mg/L as | | | | | | | |
|---|---|---|---|---|---|---|---|---|---|---|---|---|
| DOSE 2.7 mg/L as ClO₂ | | | | | ClO₂ | | | | | | | |
| | | | | Sum | | | | Sum | DOSE 10.8 mg/L as ClO₂ | | | |
| | | | | of | | | | of | | | | Sum |
| Contact | ClO₂ | ClO₂₋ | HoCl | *Cl | ClO₂ | ClO₂₋ | HoCl | *Cl | ClO₂ | ClO₂₋ | HoCl | of |
| time | as | as | as | as | as | as | as | as | as | as | as | *Cl |
| min. | ClO₂ | ClO₂₋ | Cl₂ | Cl₂ | ClO₂ | ClO₂₋ | Cl₂ | Cl₂ | ClO₂ | ClO₂₋ | Cl₂ | as Cl₂ |
| 0 | 2.7 | 0.14 | 0.24 | 3.08 | 7.80 | 0.41 | 0.69 | 8.90 | 10.80 | 0.56 | 0.95 | 12.31 |
| 5 | 0 | 0.17 | 0 | 0.36 | 1.28 | 2.78 | 0 | 9.20 | 3.10 | 2.50 | 0 | 13.41 |
| 20 | 0 | 0.20 | 0 | 0.45 | 1.03 | 2.76 | 0 | 8.52 | 2.17 | 2.89 | 0 | 11.78 |
| 35 | 0 | 0.0 | 0 | 0 | 0.84 | 2.52 | 0 | 7.52 | 2.07 | 3.42 | 0 | 12.64 |

*Sum of Cl = ClO₂ + ClO₂₋ + C 2 + mono chloramine as Cl₂

TABLE VII
Disinfection of Trickling Filters Effluents with Various Doses of ClO₂ and
Contact Times

| ClO₂ | Contact | Total | Total | Confirmed | Fecal Coli | |
|---|---|---|---|---|---|---|
| Dose | Time | Count per | Coliform | Coliform per | EC Media | Streptococcus |
| mg/L | min. | 100 mL | per 100 mL | 100 mL | per 100 mL | per 100 mL |
| 0 | 0 | 2 × 108 | 3.3 × 10⁷ | 3.3 × 10⁷ | 3.3 × 10⁷ | 1.85 × 108 |
| 2.7 | 5 | 6.75 × 10⁷ | 2.4 × 10⁷ | 1.3 × 10⁷ | 2.4 × 10⁷ | 8.4 × 10⁷ |
| 2.7 | 20 | 5.3 × 10⁷ | 1.3 × 10⁷ | 2.4 × 10⁷ | 1.3 × 10⁷ | 2.4 × 10⁷ |
| 2.7 | 35 | 3.1 × 10⁷ | 2.4 × 10⁶ | 2.4 × 10⁶ | 3.5 × 10⁵ | |
| 5.0 | 15 | 2.0 × 10⁶ | 2.4 × 10⁶ | 2.4 × 10⁶ | 2.4 × 10⁶ | |
| 5.0 | 30 | 1.6 × 10⁵ | 7.9 × 10³ | 1.1 × 10² | 7.9 × 10 | |
| 5.0 | 45 | 9.0 × 10⁴ | 2.4 × 10³ | 7.9 × 10 | 4.6 × 10 | |
| 10.8 | 5 | 1.2 × 10⁵ | 1.3 × 10³ | 1.3 × 10³ | 9.2 × 10² | 2.7 × 10⁵ |
| 10.8 | 20 | 2.9 × 10⁴ | 3.3 × 10² | 14 | 14 | 8.0 × 10³ |
| 10.8 | 35 | 2.5 × 10⁴ | 7.9 × 10 | 7.8 | 2 | |

TABLE VIII
Effect of pH on Disinfection of Effluents with Constant ClO₂ Dose 9.86 mg/L
and 30 Minutes Contact Time. MPN per 100 ml.

| | pH | | Total | Confirmed | | | |
|---|---|---|---|---|---|---|---|
| | Initial | Final | Coliforms | Coliforms | Fecal Coli | Total Count | E-Coli Phage |
| Control | 7.5 | — | 4.9 × 10⁷ | 4.9 × 10⁷ | 4.9 × 10⁷ | 2.4 × 10⁵ | 2.4 × 10⁵ |
| Control | 4.6 | — | 4.9 × 10⁷ | 3.3 × 10⁷ | 1.1 × 10⁷ | 2.0 × 10⁴ | 4.3 × 10⁴ |
| Control | 10.0 | — | 1.3 × 10⁷ | 1.3 × 10⁷ | 1.3 × 10⁷ | 4.0 × 10⁴ | 2.4 × 10⁵ |
| | 4.6 | 4.4 | 4.5 | 2 | 2 | 5 | 0 |
| | 5.5 | 5.6 | 7.8 | 2 | 2 | 15 | 0 |
| | 6.5 | 6.7 | 7.8 | 4.5 | 0 | 30 | 0 |
| | 7.5 | 7.6 | 49 | 17 | 1.8 | 1 × 10² | 0 |
| | 8.2 | 8.1 | 4.6 × 10² | 33 | 23 | 2 × 10² | 2 |
| | 9.1 | 9.2 | 5.4 × 10³ | 7.9 × 10² | 2.7 × 10² | 2.5 × 10³ | 79 |
| | 10.0 | 10.0 | 2.4 × 10⁴ | 1.3 × 10⁴ | 1.3 × 10⁴ | 6.8 × 10² | 79 |

### Example 1

### The Southwell Dairy Treatment system

This system is unique as to the manner in which the constituent parts are used and also how the ingredients making the chlorine dioxide diluent are assembled.

This study was undertaken to determine the efficacy of Southwell Extender, a proprietary oxy-chlorine sanitiser and a commercially available acid and alkali product in conjunction with a reduced hot water regime and find if results regarding milk quality were compromised by the use of the system.

Costs of traditional chemicals were compared with use of the Southwell system.

Conclusions

Milk quality results were not compromised by using the Southwell system.

Actual power consumption readings showed a fall in the amount of power used.

| November | |
|---|---|
| TOTAL | 1852.47 |
| January | |
| TOTAL | 1075.26 |
| May | |
| TOTAL | 912.64 |
| Cleaning material costs | |
| Alkali | 140.00 |
| Acid | 800.00 |
| Extender | 1100.00 |
| TOTAL CLEANING MATERIAL COSTS | 2040.00 |

Materials and Procedures

The farm is located in the Northern Wairarapa and milks two hundred and sixty cows in a twenty four a side herringbone shed.

The selected santiser, bio-film remover, was Southwell Extender, Chlorine dioxide in aqueous diluent <1000 ppm (approval number h 2166a.) and it was obtained from Southwell Products Ltd.

It was noted that approval for the use of this product will be subject to the following conditions as per NZFSA requirements:

1. To be used as part of a cleaning regime that includes hot water cleaning

FIL Impact Blue, a caustic cleaner based on sodium hydroxide was obtained from a farm supplier and was used as the alkali cleaner during the period of the study

FIL JetSet, a phosphoric acid, was the selected acidic cleaner.

All materials were used as recommended by the respective manufacturers i.e.

Extender 240 mls per 360 litres of water

The plant was cleaned prior to the beginning of the season with seven hot acid washes in the morning and with seven hot alkali washes in the afternoon. The plant was rinsed with potable water after each wash.

Southwell Products recommended the following regime . . . .

| | Day | | | | | | |
|---|---|---|---|---|---|---|---|
| | 1 | 2 | 3 | 4 | 5 | 6 | 7 |
| a.m. | | | | | | | |
| Alkali Hot | X | —* | X | —* | X | —* | X |
| Acid Hot | —* | X | —* | X | —* | X | —* |
| p.m. | | | | | | | |
| Extender cold | X | X | X | X | X | X | X |

Followed by cold potable water rinse with a typical recycle time of ten minutes
On the trial farm the following system was adopted

| | Day | | | | | | |
|---|---|---|---|---|---|---|---|
| | 1 | 2 | 3 | 4 | 5 | 6 | 7 |
| a.m. | | | | | | | |
| Alkali Hot | X | —* | —* | —* | —* | —* | —* |
| Acid Hot | —* | —* | —* | —* | X | —* | —* |
| p.m. | | | | | | | |
| Extender cold | —* | —* | —* | —* | —* | —* | —* |

Followed by cold potable water rinse with a typical recycle time of ten minutes
As part of a secret trial the following system was adopted

| | Day | | | | | | |
|---|---|---|---|---|---|---|---|
| | 1 | 2 | 3 | 4 | 5 | 6 | 7 |
| a.m. | | | | | | | |
| Alkali Hot | X | —* | —* | —* | —* | —* | —* |
| Acid Hot | —* | —* | —* | —* | X | —* | —* |
| p.m. | | | | | | | |
| Extender cold | —* | —* | —* | —* | —* | —* | —* |

—* Extender wash

Followed by cold potable water rinse with a typical recycle time of ten minutes

All pipes and joins were cleaned four times in the season; at the start of the season, after calving, after mating and in March.

The vat was cleaned using two cold acid washes per week and the remainder using Southwell Extender.

Monitoring of the performance of the operation was done by Fonterra and energy consumption data was supplied by Genesis Energy.

Results

The milk quality results were as follows

| Day | SCC | Bacto. | Coliforms | Inhabs | Thermos |
|---|---|---|---|---|---|
| November | | | | | |
| 10 | 203 | — | — | — | — |
| 9 | 221 | — | — | — | — |
| 8 | 227 | — | — | — | — |
| 7 | 210 | — | — | — | — |
| 6 | 165 | — | — | — | — |
| 5 | 158 | — | — | — | — |
| 4 | 177 | A+ | — | — | — |
| December | | | | | |
| 10 | 173 | — | — | — | — |
| 9 | 169 | A+ | — | — | — |
| 8 | 140 | — | — | — | — |
| 7 | 153 | — | — | — | — |
| 6 | 154 | — | — | — | — |
| 5 | 163 | — | — | — | — |
| 4 | 138 | — | | | |
| January | | | | | |
| 10 | 163 | — | — | — | — |
| 9 | 160 | A+ | | — | — |
| 8 | 133 | — | — | — | — |
| 7 | 146 | — | — | — | — |
| 6 | 170 | — | — | — | — |
| 5 | 135 | — | — | — | — |
| 4 | 135 | — | _{—} | — | — |
| February | | | | | |
| 10 | 189 | — | — | — | — |
| 9 | 231 | — | — | — | — |
| 8 | 238 | — | — | — | — |
| 7 | 165 | A+ | — | — | — |
| 6 | 159 | — | — | — | — |
| 5 | 163 | — | — | — | — |
| 4 | 193 | — | — | — | — |
| March | | | | | |
| Day | SCC | Bacto. | Coliforms | Inhabs | Thermos* |
| 10 | 707 | — | — | — | 100 |
| 9 | 357 | — | — | — | 1600 |
| 8¹ | 162 | — | — | — | 1700 |
| 7 | 175 | — | — | — | 1800 |
| 6 | 169 | — | — | — | 1200 |
| 5 | 191 | — | — | — | 1800 |
| 4 | 171 | A+ | — | — | 700 |

8¹change to once a day milking
*Thermos due to perished rubber ware, dirty milk air lines and not
attributable to plant cleaning

| April | | | | | |
|---|---|---|---|---|---|
| Day | SCC | Bacto. | Coliforms | Inhabs | Thermos |
| 10 | 249 | — | — | — | — |
| 9 | — | — | — | — | — |
| 8 | 240 | — | — | — | — |
| 7 | — | — | — | — | — |
| 6 | Unavailable | | Unavailable | | Unavailable |
| 5 | — | — | — | — | — |
| 4 | 253 | A+ | — | — | — |

### Power Consumption

Actual Power reading at: -November (Contains part of October)

| | | Cost | |
|---|---|---|---|
| | Units used | Cents | Extension |
| Business Night | 2903 | 12.10 | 351.26 |
| Business Day | 5455 | 26.98 | 1471.76 |
| Daily fixed charge | 31 days at | 95.00 | 29.45 |
| TOTAL | | | 1852.47 |

### January

| | | Cost | |
|---|---|---|---|
| | Units used | Cents | Extension |
| Business Night | 871 | 12.10 | 105.39 |
| Business Day | 3468 | 26.98 | 935.67 |
| Daily fixed charge | 36 days at | 95.00 | 34.20 |
| TOTAL | | | 1075.26 |

### May

| | | Cost | |
|---|---|---|---|
| | Units used | Cents | Extension |
| Business Night | 1094 | 12.10 | 132.37 |
| Business Day | 2781 | 26.98 | 750.32 |
| Daily fixed charge | 31 days at | 95.00 | 29.95 |
| TOTAL | | | 912.64 |

Use in chilled and refrigerated water or brine to extend the shelf life of fish

Previous to the introduction of the Southwell System high cost fish such as tuna caught in long line fishing voyages were gutted and wrapped in muslin and suspended by the tail in a tank containing chilled/refrigerated sea-water. This procedure was employed to retard the proliferation of spoilage mechanisms. Under the above regime voyage times were nine days.

The introduction of Southwell Extender chlorine dioxide in aqueous diluent has extended voyage times to sixteen days with any visible deterioration of the fish.

Trials on various fruits, vegetables and other products subject to rapid spoilage have shown considerable resistance to spoilage mechanisms.

Also surprisingly, this process has particularly use in the field of embalming and especially the mortuary environment where a cadaver is flushed using chlorine dioxide in aqueous solution in conjunction with a use system devised by Mr. Adrian Featherstone of Mortech Industries (NZ) Ltd.

Use of chlorine dioxide with various additives to exhibit new uses

Chlorine dioxide does not mix readily with other materials because of its oxidative effect. However there are uses where it is desirable to have the aqueous diluent to be part of new carrier.

To this extend we have adopted a system of not trying to blend the diluent with the new material but rather use it as part of the reaction thereby extending its stability from “mix on the day” to periods in excess of three months.

Preferably, with a carrier such as glycerin to act as a fixative in the manufacture of a teat spray to be used in the dairy industry

Preferably, with a surfactant to be used as a detergent for the lifting of fat and protein spoils while also having a disinfectant effect.

In one embodiment the stabilised chlorine dioxide solution is added to refrigerated sea-water preferably at zero point five degrees Celsius (0.5 deg. C.) at a rate of one litre (1 L.) per one thousand litres (1000 L.) of sea-water. The effect of the stabilised chlorine dioxide solution is to suppress the growth of spoilage bacteria thereby allowing voyage times to be extended from nine (9) to sixteen (16) days.

This embodiment has been refined to add four hundred millilitres (400 ml.) of stabilised chlorine to one thousand litres (1000 L) of water used in the making of ice in commercial ice making machines. When the ice is packed around fish the change in temperature releases the stabilised chlorine dioxide and has the suppressing effect on spoilage bacteria as above

A further embodiment see stabilised chlorine dioxide introduced into cadavers with the effect that on contact with spoilage bacteria in the bodies system retardation takes place thereby holding back the natural decomposition of the body.

In agriculture and horticulture stabilised chlorine dioxide has been used as both a topical spray and also inoculated into the plant itself.

Introduction to Biofilms

Many bacteria are planktonic, that is they float around in water. Most microbiological work is done using these suspended cultures on water samples.

Most of the bacteria that cause problems are sessile, attached to a surface. Once bacteria attach to a surface they change.

The most obvious change is that they begin to excrete a slimy material, hence the source of the derivation of the word biofilm. However, research is showing that biofilm is not merely the provision of the excretion of slimy material but rather they are showing that bacteria which attach to a surface turns on a whole different set of genes which effectively makes it a significantly different organism to deal with compared to the planktonic material.

Bacteria living in a biofilm do a number of things differently from the single planktonic cells of the same type of bacteria e.g. Pseudomonas aeruginosa, and these are:

There is a division of labour in a biofilm where some cells utilise the available nutrients to turn on metabolic pathways. Other cells utilise degradation products (suspended solids, corrosion products, dead bacteria and algal cells) to produce new cells that are dispersed into the biofilm environment.

In biofilms, bacteria (film forming fungi can also form biofilms) employ cell-cell communication which is now termed quorum sensing where they sense the level of increased cell population density and they release and detect hormone-like molecules that accumulate in the surrounding aquatic environment as the bacterial cell density increases.

The biofilm having achieved this quorum sensing shows vast differences in heterogeneity from the same bacterial species in different environments.

The biofilm having achieved this quorum sensing status can begin to excrete toxins and polysaccharides, change the properties of the original bacterial cell, and change the shape of the biofilm.

Characteristics of Biofilms

Biofilms consist of:

water (85% to 95% by weight)

Microbial cells

Extra-cellular polymeric substances (EPS) such as polysaccharides, proteins and other biopolymers, Suspended solids, Corrosion products, Algal material, Fungi & Protozoa.

The biofilms grow in micro-colonies embedded in the EPS structure which are interspersed with less dense regions containing highly permeable water channels. Counting of individual micro-organisms in a biofilm is not practical and in addition a number of species in the growing biofilm can not be cultured.

Research has shown that there is no difference in the rate of colonization across different types of supporting material (glass, stainless steel, rubber lining). The actual number of viable cells in the biofilm will differ in terms of absolute number of colonies.

Biofilm structure is very dependent upon fluid velocity of the water, nutrient load, temperature, pH, electrostatic potential, biocide concentration and biocide contact time. Change a process parameter and the biofilm structure changes. Biofilms can grow across a vacuum.

There are four ways by which detachment of biofilm from a surface takes place,

Erosion, small particles from the biofilm surface being detached into the bulk fluid

Sloughing, large pieces of biofilm being detached

Abrasion, detachment by collision of solids

Grazing, removal of biofilm due to its consumption by higher organisms such as protozoa

These four different methods of detachment each exert a different response in counting microbiological colonies in bulk water samples and they exert different effects on disinfectant or biocide efficacy.

Detachment of biofilm can occur by increasing the flow rate of water to greater than 3-4 metres per second. Fluid shear forces cause erosion whilst high fluid velocities cause abrasion and sloughing.

Sloughing of biofilm is caused by disinfectants or biocides.

Detachment of biofilm is dominated by the electrostatic interaction in cell to cell attachment. Change in electrostatic potential can change the biofilm structure.

The structure of biofilms is a function of the spatial distribution and homogeneity of the biofilm in a water circuit, hence, the importance of measuring spatial distribution of biofilm.

The structure of biofilms depend on the following, Turbulent flow produces homogeneous and slimy biofilms. Laminar flow produces a scattered biofilm with significant protuberances. Laminar flow biofilms are more easily inactivated than turbulent flow biofilms.

Turbulent flow biofilms are more active as seen by the increase in respiratory conditions for the micro-organisms, have less EPS but higher protein content. (Proteins which contain glycine, lysine and histidine react with many disinfectants/biocides like chlorine, bromine, ozone, glutaraldehyde, QAC's, peracetic acid products, hydrogen peroxide. Please note there is no reaction with chlorine dioxide)

The effect of disinfectants or biocides is related to the age of the biofilm. Younger biofilms are easier to remove but age is relative for each system as age varies from minutes to days.

Shock dosing of a disinfectant or biocide has been demonstrated to be significantly more superior to continuous low level dosing in the removal or detachment of biofilms. In many cases the level of detachment of biofilm changes by factors of 10 to 100 times for shock dosing compared to continuous dosing.

The decrease in the susceptibility of biofilms to disinfectants or biocides has been proven to be influenced by phenotypic characteristics of the adherent cells and biofilm rather than biofilm structure, the various cells in the biofilm of the same bacterial type, that originally formed the biofilm undergo physical or chemical changes due to the formation of the biofilm thereby they exhibit different properties to their planktonic relatives.

Biofilms do not grow in homogeneous structures. They change their shape, size and other chemical or physical characteristics across any given unit area and across the whole system, spatial distribution of the biofilm is a major factor in determining the ease of detachment of the biofilm.

In potable water distribution systems biofilm formation leads to a deterioration of the microbiological quality of the treated water resulting in:

Re-growth of coliforms of non-faecal origin

Multiplication of opportunistic pathogens like Aeromonas, Pseudomonas and Legionella

Increased heterotrophic plate counts

Colour, odour and taste problems

Microbiologically induced corrosion (MIC)

Induction of scaling

The provision of protective places for pathogenic bacteria

Microbial measurement in potable water systems poses special problems mainly related to the low amount of bacteria present, low levels of nutrients in the potable water and their low activity.

The best suited techniques are those that are very sensitive to these small changes.

Impact of Disinfectants/Antimicrobials/Biocides on Biofilms

Glutaraldehyde has been shown to provide a protective effect on cells against lysis and has no effect on biofilm at 200 ppm levels

The most widely tested compounds used to control biofilm have been chlorine, hydrogen peroxide, Quaternary Ammonium and peracetic acids. These chemicals have been shown to have very poor to no effect on biofilm detachment.

Ozone has been shown to kill cells in the biofilm without any detachment of the biofilm. Re-growth of the micro-organism population 2 to 4 days later is evident with ozone treatment.

Biofilms have been shown to grow across UV lights quite readily.

The latest research by G. Gagnon, Dalhousie University in Canada has shown that chlorine dioxide and chloramines are very effective in the detachment of biofilms in potable water distribution systems

There is no one mechanism rather researchers believe that there are 3 broad categories:

Reduction of the antimicrobial concentration in the water surrounding the biofilm

The antimicrobial agent is depleted to ineffectual levels before it gets to the biofilm.

Failure of the Antimicrobial Agent to Penetrate the Biofilm

The antimicrobial agent is delivered to the surface of the biofilm but it does not effectively penetrate the biofilm.

Adoption of a resistant physiological (phenotype) by at least a fraction of the cells in the biofilm

The antimicrobial agent permeates the biofilm but it is unable to kill micro-organisms because they exist in a phenotype state that confers reduced susceptibility.

The reduced susceptibility of biofilms has not been attributed to the usual mechanisms of mutation or acquisition of genetic elements that cause specific resistance genes that account for conventional antibiotic resistance. For these mechanisms to explain biofilm resistance, the genetic modification would have to appear in the biofilm but absent in the planktonic state, this is not happening.

Some research has also shown that the amount of biofilm removed and the reduction in viable cell numbers in the biofilm were not correlated. Some antimicrobial agents cause significant killing but not much removal of biofilm and vice versa. This underscores the fact that biofilm removal and cell killing are distinct processes and both need to be fulfilled to have a successful treatment.

Measurement showed that in an ice water system in one winery a residual of 1 ppm chlorine dioxide gives results while at another, good results were only obtained with 3 ppm residual.

Research has shown that a shock dose of an antimicrobial will do more damage to the biofilm than a low continuous dose and this is easily explained by the three mechanisms which explain antimicrobial resistance. There is a minimum inhibition concentration (MIC) that any antimicrobial requires before it can inactivate a bacteria cell.

It is obvious that the MIC for the same type of bacteria can differ from site to site which explains why one begins to get a good result but one week the bacteria counts are high again. A shock dose at this point will get on top of the problem.

Chlorine dioxide is a more effective antimicrobial than most other chemicals because of its small molecule; it is non ionic, it is a gas, it is highly soluble in organics, it does not react with polysaccharides, has very few chemical reactions and is stable in water with a measurable residual.

Even with these characteristics there is no “standard” level for removal of biofilm.

Overview to Biofilm Monitoring

Bio-fouling is a biofilm problem it is an undesired deposition and growth of micro-organisms on surfaces such as heat exchangers, water storage and distribution systems and in medical applications. These biofilms cause significant economic losses. Any strategy which incorporates anti-fouling technologies will be more cost effective if the extent of the biofilm could be monitored on-line in real time without destroying the biomass formation.

Current bio-fouling monitoring techniques rely on the removal of biomass from the system in the form of coupons that have been exposed to the fluid for a given period of time. These samples are then analysed which is time consuming and requiring skilled personnel. Furthermore, current biofilm control technologies are based on

Monitoring the process performance or product quality, the biofilm is detected only after it has already caused economic losses.

Biofilm monitoring is based on decisions made from the results obtained from bulk water samples. It has been shown above that there is no correlation or relationship between planktonic bacteria and sessile bacteria of the same type.

Biofilm is usually treated as a disease of the plant process water. If the organisms in the bulk water are killed a cure of the disease is made.

Disinfectants are used to kill the organisms in the bulk water, however, they will leave dead biomass in the system that accumulates and promotes re-growth of the organisms by using the dead biomass as a nutrient source. (In many instances the real problem is the biomass of the biofilm).

Some oxidising disinfectants (like chlorine dioxide) cleave the bonds between the extra cellular polymeric substances (EPS) which are responsible for the attachment of the biomass. This detached biomass needs to be inactivated, by shock dosing, so as to stop the re-growth potential.

Biofilms are resistant to many disinfectants like chlorine, ozone, peracetic acid because they only cause cell deaths and re-growth of the biofilm is evident. In these instances a “saw tooth curve” of micro-organism levels is evident.

In most instances the amount of nutrients in a system is not limited. Oxidants like ozone can actually increase the amount of assimable organic carbon content thereby increasing the biomass quantity.

Biofilms are evident some time after formation. Research has shown that detachment of the biofilm is dependent upon its age, the type of disinfectant or biocide used; its concentration and contact time available in the system.

The general mode of operation is for the significant over use of poorly selected disinfectants or biocides that result in economic or environmental concerns and costs.

Contemporary bio-fouling control strategies operate with information from water samples and blindly applying disinfectants or biocides because they kill these organisms in the planktonic state.

Bio-Fouling Monitors Operate on Four Levels

Measurement of the Kinetics of Deposition of Material and Changes to the Physical Properties of the Deposit

These systems cannot detect the difference between micro-organisms (biotic) and abiotic deposit components like corrosion deposition, suspended solids, scale and non micro-organisms. Kinetics based systems work on a variety of parameters like light scattering; turbidity measurements; electrochemical changes in conductance; redox potential and heat transfer exchange resistance.

Systems which can Distinguish Micro-Organisms (Biotic) and Abiotic Deposits in a Biofilm

These systems can measure the kinetics of deposition of biofilms and some measure the spatial distribution of biofilms. They can be used to correlate biofilm structure with absorbance for a given set of plant conditions. They can also be used to monitor disinfectant or biocide efficacy by changes in biofilm structure.

These systems use infrared sensors, fluorescence or microscopic observations.

Systems that provide detailed chemical and or physical composition of the biofilm.

They use sophisticated spectroscopy and microscopy analysis and currently are only suitable for biofilm research and not for use in industry.

Systems can discriminate between living and dead organisms within the biofilm surface.

To-date no such equipment exists.

Bio-fouling monitoring is direct, on-line, in-situ, continuous, non-destructive real time information regarding biofilm in a specific system. Industrial process water or potable water is not a sterile system hence there is a level of biofilm in all systems which is inherently present without causing problems to that system.

The difficulty lies in determining the “base-line” for each system.

Bio-fouling monitoring is basically a means of monitoring physical, chemical parameter(s) it is not a means of quantifying biofilm function.

Currently there is no way of doing this.

Biofilms do not conform to any mathematical model; they vary in thickness, density and physical or chemical composition from point to point in any given biofilm in any given process water system. Bio-fouling monitoring is a means of measuring and comparing specific parameter(s) in biofilms in a specific, process over a period of time.

Optimising the type of disinfectant or biocide to be used, cleaner applications that require more sophisticated monitoring strategies and different bio-fouling removal technologies are going to become the state of the art techniques to optimise disinfectant or biocide usage.

Biofilm Control Strategies

Selection of the right disinfectant/biocide and the most cost effective shock dose timing regime

The applied dosing of the appropriate disinfectant or biocide in a biofilm control strategy will need to satisfy the following conditions:—

Low redox potential

No hydrolysis or dissociation in water

Few chemical reactions particularly with polysaccharides, proteins, enzymes and b-polymers

High solubility and stability in hydrocarbons

Identification of biofilm formation, above the level of the baseline biofilm that no time is wasted in remedial action

Changes in process conditions alter the rate of colonisation and biofilm characteristics. Bio-fouling monitoring needs to be sensitive to these changes.

Each system will have different biofilm characteristics even if the same bacteria type is the responsible organism, e.g. slime formers, SRB's etc. Dosing patterns will vary.

Detachment of biomass, in most cases, is important without causing process or product contamination. Only killing of cells prevents re-growth. (Soak and disinfect process off-line will achieve these results provided the disinfectant can remove biofilm).

Shock dosing in terms of concentration and time between intervals will vary from system to system. The only method of effectively monitoring the cost effectiveness of this treatment is by using a bio-fouling monitor which can monitor disinfectant or biocide efficacy.

Biofilms contain areas of highly permeable water channels. Disinfectants or biocides efficacy requires a diffusion time for the product through these channels. Over a period of time more biofilm is removed and the disinfectant biocide shock dosing pattern will be reduced.

Bio-fouling control is a sophisticated science with no standard method to treat similar systems. There is a need for product optimisation used in conjunction with a bio-fouling monitor prior to attaining the desired results but this process will be far more cost effective then blindly adding a disinfectant or biocide in the hope of controlling biofilms.

A number of techniques will be needed to be used to achieve the most cost effective treatment programme.

The focus of our bio-fouling control strategy will be centred on a biomass SCOPE to give us on-line real time information about the start of biofilm formation. At this point the biofilm is at its weakest state. The SCOPE unit will give a digital signal at the outset of the biofilm formation which will then activate a chlorine dioxide shock dose. The duration of this shock dose will be determined by the SCOPE and through empirical results from the monitored process parameters.

As is evident from all the research on biofilms there is no “standard” method of removal and killing of biofilm. Each system is to be evaluated individually and in terms of the customer's requirements taking into account:

Process performance

Product integrity

Regulatory issues HACCP, Eurogap, Food Safety, ISO 14000 environmental discharge regulations, FDA, EPA and EU approvals

Cost effectiveness

Microbiological efficacy

To achieve these requirements we will make use of:

Soak And Disinfect Procedures:

Chlorine dioxide has been shown to be hugely effective in the removal of biofilm biomass through the use of a soak and disinfect process.

The water storage and distribution system is treated with 5 to 15 ppm residual chlorine dioxide solution which is then held for periods of 1 hour to 24 hours at this residual.

The nett result is the removal of the biofilm biomass which can create its own array of problems.

Bio-Dispersants

The concept of Bio-dispersants is widely used in the treatment of cooling systems. We now have an on-line means of determining the most cost effective bio-dispersant. Bio-dispersants are used on a shock dose basis and the intervals between shock doses can be optimised for each system in order to maximise results with costs.

Shock Dosing Chlorine Dioxide

Most industries are happy to undertake continuous dosing of chemicals, chlorine dioxide included, however shock dosing will in fact give more effective results. The Biomass detector will allow us to wean industry off continuous dosing and use shock dosing. Where there are significant cost benefits to be derived from using shock dosing.

Synergistic Antimicrobial, Biocide Combinations

There is no ideal biocide, so there is room in the fight against BIOFILM, BIOMASS to use combination products for the most effective results. These combinations will be determined, by the nature of the process and extent of the problem.

Ozone and UV light in potable water for the quick kill and chlorine dioxide for the residual

Chloramines Together with Chlorine Dioxide

The chloramines is used as the residual source and the chlorine dioxide to breakdown the biofilm and nitrifying bacteria

QAC (QUAT) products in combination with chlorine dioxide, QAC products have great wetting ability.

Some biocides have longer half-life than chlorine dioxide in cooling water systems so combinations would provide cost effective solutions.

Furthermore, bio-dispersants programmes with chlorine dioxide could well reduce the need for re-tubing condensers in power plant circuits.

Non-oxidising biocides in combination with chlorine dioxide (an oxidising biocide) will provide maximum insurance against organisms showing resistance to any biocide. This is equally important in cooling towers as well as in the cleaning of poultry houses particularly in the latter case against the spread of the quick mutating avian flu virus which is wreaking havoc in the poultry industry in Asia.

Biofilm control strategies will need to have multiple levels of attack not blindly taking surface water samples and adding a biocide at a rate that the customer deems affordable.

We are able to show our customers that we have the capability to measure the problem and the solution.

Whilst the invention has been described with reference to specific embodiments, it will be appreciated that various modifications and improvements could be made to these embodiments without departing from the scope of the invention as set out in this specification.

All references, including any patents or patent applications cited in this specification are hereby incorporated by reference. The applicant makes no admission that any reference constitutes prior art—they are merely assertations by their authors and the applicant reserves the right to contest the accuracy, pertinency and domain of the cited documents. None of the documents or references constitute an admission that they form part of the common general knowledge in NZ or in any other country.

### EQUIVALENTS CLAUSE

The Invention may also broadly be said to consist in the parts, elements and features referred or indicated in the specification, individually or collectively, and any or all combinations of any of two or more parts, elements, members or features and where specific integers are mentioned herein which have known equivalents such equivalents are deemed to be incorporated herein as if individually set forth.

### MODIFICATIONS AND VARIATIONS

The invention has been described with particular reference to certain embodiments thereof. It will be understood that various modifications can be made to the above-mentioned preferred embodiment(s) without departing from the ambit of the invention.

Variations can include the steps involved to obtain the desired stabilised end product and scalability.

The skilled reader will also understand the concept of what is meant by purposive construction.

The examples and the particular proportions set forth are intended to be illustrative only and are thus non-limiting.

Throughout the description and claims of the specification the word “comprise” or variations thereof are not intended to exclude other additives, components or steps.

### Kit of Parts

It will also be understood that where a product, method or process as herein described or claimed and that is sold incomplete, as individual components, or as a “Kit of Parts”, that such exploitation will also fall within the ambit of the invention.

In a preferred embodiment the invention includes within its scope a kit of parts, the kit of parts providing for a stabilised solution of ClO₂ for use as a sanitiser comprising in separate containers or as separate mixable compartments within the same container:

(A) a chlorite salt and
(B) a suitable acid and
(C) an additional chlorite salt
and wherein components (A), (B) & (C) are combined at steps and in amounts effective to provide for enhanced ClO₂ stability

What is claimed is:

1. An aqueous stabilised chlorine dioxide solution for use as a universal biocide comprising:
(A) an effective stabilising amount of ClO₂⁻ ions and
(B) an effective biocidal amount of ClO₂,
(C) an acidulator sufficient to release ClO₂, in a safe manner, and
(D) an amount of water qs,
the solution being characterised in that the molar ratio of components (A):(B) is from 20:1 to 1:20.

2. The stabilised chlorine dioxide solution according to claim 1 wherein the molar ratio of components (A):(B) is from 5:1 to 1:20.

3. The stabilised chlorine dioxide solution according to claim 1 wherein the acidulator is HCl or H₂ SO₄ and the chlorite ions are provided as sodium chlorite.

4. The stabilised chlorine dioxide solution according to claim 1 for use as a sanitiser or disinfectant for the following selected from: ground water, waste water, sewage, in the food industry, in hospitals, medical centres, rest homes, in agriculture, aquaculture, fishing, poultry, horticulture, viticulture, the hotel and travel industry, and in the mortuary environment.

5. The stabilised chlorine dioxide solution according to claim 1 for use in the control or suppression of one or more organisms selected from bacteria, viruses, yeasts, fungi, preons and actinomycetes.

6. The stabilised chlorine dioxide solution according to claim 1 for use in the control or suppression of infection in susceptible environments selected from: vineyards, fruit orchards, milk sheds; poultry sheds, municipal, commercial and domestic water systems, vineyards, fish processing factories, fishing boats, fish farms and poultry sheds.

7. The stabilised chlorine dioxide solution according to claim 1 wherein the composition is formulated as a concentrate or as a ready-to-use solution.

8. The stabilised chlorine dioxide solution according to claim 1 wherein the solution is stable for at least 14 months.

9. The stabilised chlorine dioxide solution according to claim 1 further comprising, in combination, one or more additional biocides selected from ozone, UV light, chloramines, bio-dispersants and non-oxidising biocides.

10. The stabilised chlorine dioxide solution according to claim 1 further comprising 1 to 99% on a w/w basis or a w/v basis one or more customary formulation additives.

11. A method of preparing a stabilised chlorine dioxide solution according to claim 1 by the following means:
(i) Take 500 grams of 80% sodium chlorite and dissolve in water
(ii) add water to a two hundred litre container and
(iii) add the solution prepared at step (i);
(iv) at a level of one hundred litres of water add 500-1000 mls of a Generally Recognised as Safe Acid (GRAS) at a concentration of 32% w/v
(v) at a water level of one hundred and fifty litres add a further 25 grams of sodium chlorite and prepare and add one litre 16% w/v solution of the GRAS to the water and
(vi) fill to 200 Litres.

12. A method for the control or suppression of infection which comprises applying at a desired location the stabilised chlorine dioxide solution according to claim 1.

13. The method of claim 11 wherein the stabilised chlorine dioxide solution is applied by conventional means including spraying, flushing, dowsing, wiping, pouring, or wicking.

14. The method of claim 11 wherein the stabilised chlorine dioxide solution is applied simultaneously or sequentially.

15. The use of stabilised chlorine according claim 1 in the manufacture of a biocidal composition for the control or suppression of infection.
